(19) United States
(12) Patent Application Publication
(10) Pub. No.: US 2025/0087103 A1
(43) Pub. Date: Mar. 13, 2025

(54) CONTROLLING SYSTEM, NAVIGATION SYSTEM, MONITORING SYSTEM, RUNWAY INCURSION SYSTEM, NAVIGATION SYSTEM, GUIDANCE AND SAFETY SYSTEMS, PROCESSES, AND METHOD OF USE

(71) Applicant: Ivry Shapira, Oranit (IL)

(72) Inventor: Ivry Shapira, Oranit (IL)

(21) Appl. No.: 18/829,708

(22) Filed: Sep. 10, 2024

Related U.S. Application Data
(60) Provisional application No. 63/537,522, filed on Sep. 10, 2023.

(51) Int. Cl. G08G 5/00; G08G 5/04

(52) U.S. Cl. CPC G08G 5/55; G08G 5/32; G08G 5/34; G08G 5/58; G08G 5/80

(57) ABSTRACT

A control system, a navigation system, a monitoring system, a runway incursion system, a navigation system, a guidance system, a safety system, processes, and methods of use are presented. More specifically, and without limitation, the present disclosure relates to an autonomous navigation system, a dynamic path guidance system, an emergency response system, an autonomous vehicle navigation system, processes, and methods of use. More specifically, and without limitation, the present disclosure relates to an airport navigation and safety system.

### CROSS-REFERENCE TO RELATED APPLICATIONS

The present application claims priority to the U.S. Provisional Patent Application No. 63/537,522 which was filed on Sep. 10, 2023, which is hereby incorporated by reference herein in its entirety, including any figures, tables, or drawings.

### FIELD OF THE INVENTION

This disclosure relates to a control system, a navigation system, a monitoring system, a runway incursion system, a navigation system, a guidance system, a safety system, processes, and methods of use. More specifically, and without limitation, the present disclosure relates to an autonomous navigation system, a dynamic path guidance system, an emergency response system, an autonomous vehicle navigation system, processes, and methods of use. More specifically, and without limitation, the present disclosure relates to an airport navigation and safety system.

### BACKGROUND OF THE INVENTION

In recent times, airport control systems have grown in complexity. Airport traffic is hitting record numbers while systems are aging and in many cases decades old. These aged systems are not designed to handle the number of transactions being handled. Complicating matters further, airport personnel are scarce and not able to fill the needed times (which are typically 24 hours per day).

Traffic controllers have high stress jobs which require critical attention to detail and handling of mass amounts of information. This is especially complicated when a lack of sleep for personnel is considered.

Said another way, air traffic control and/or air traffic controllers are a service which is well known in the art. Ground-based air traffic controllers, specifically have a challenging job as radar does not pick up on all the airplanes taxiing, the buses carrying passengers, fuel vehicles, maintenance vehicles, emergency vehicles, emergency services as more. Ground based air traffic controllers direct aircraft on the ground through a dizzying maze of complex and overlapping runways and the like. The primary purpose, then, of ground controllers is to prevent collisions, organize and expedite the flow of air traffic and provide pilots and others with important support.

Complicating matters further, even if air traffic controllers deliver correct instructions to a pilot, the pilot must interpret this information and take an appropriate path to an appropriate place. These places may be unfamiliar as airports exist around the world and grow in number and complexity regularly.

To prevent collisions and the like, air traffic controllers must enforce strict, complex rules which may vary from region to region. For these reasons, and others, airport and navigation safety are extremely important and more complex than ever.

Thus, there is a long-felt need in the art for a safe, effective, and efficient method of ground-based navigation and air traffic control which also prevents delays and the like while providing effective transportation and timeliness.

The disclosure herein provides these advantages and others as will become clear from the specification and claims provided.

### SUMMARY OF THE INVENTION

A control system, a navigation system, a monitoring system, a runway incursion system, a navigation system, a guidance system, a safety system, processes, and methods of use. More specifically, and without limitation, the present disclosure relates to an autonomous navigation system, a dynamic path guidance system, an emergency response system, an autonomous vehicle navigation system, processes, and methods of use. More specifically, and without limitation, the present disclosure relates to an airport navigation and safety system.

Thus, it is a primary object of the disclosure to provide a control system, a navigation system, a monitoring system, a runway incursion system, a navigation system, a guidance system, a safety system, processes, and methods of use that improves upon the state of the art.

Another object of the disclosure is to provide a control system, a navigation system, a monitoring system, a runway incursion system, a navigation system, a guidance system, a safety system, processes, and methods of use that provides control and monitoring.

Yet another object of the disclosure is to provide a control system, a navigation system, a monitoring system, a runway incursion system, a navigation system, a guidance system, a safety system, processes, and methods of use that provides seamless integration of fleet monitoring.

Another object of the disclosure is to provide a control system, a navigation system, a monitoring system, a runway incursion system, a navigation system, a guidance system, a safety system, processes, and methods of use that reduces controller workload.

Yet another object of the disclosure is to provide a control system, a navigation system, a monitoring system, a runway incursion system, a navigation system, a guidance system, a safety system, processes, and methods of use that provides a quick, advanced monitoring and taxing system.

Another object of the disclosure is to provide a control system, a navigation system, a monitoring system, a runway incursion system, a navigation system, a guidance system, a safety system, processes, and methods of use that prevents runway incursions; and/or prevents any occurrence at an airport involving incorrect presence of a vehicle, whether aircraft or ground vehicle.

Yet another object of the disclosure is to provide a control system, a navigation system, a monitoring system, a runway incursion system, a navigation system, a guidance system, a safety system, processes, and methods of use that providers integrated control stations which provide digital handwriting, touchscreen, and easy operator control.

Another object of the disclosure is to provide a control system, a navigation system, a monitoring system, a runway incursion system, a navigation system, a guidance system, a safety system, processes, and methods of use that works as a standalone system with a minimalistic footprint in the control room and/or prevents space obstruction in operating areas.

Yet another object of the disclosure is to provide a control system, a navigation system, a monitoring system, a runway incursion system, a navigation system, a guidance system, a safety system, processes, and methods of use that provides a personal portable station.

Another object of the disclosure is to provide a control system, a navigation system, a monitoring system, a runway incursion system, a navigation system, a guidance system, a safety system, processes, and methods of use that provides sensing and smart decision integration.

Yet another object of the disclosure is to provide a control system, a navigation system, a monitoring system, a runway incursion system, a navigation system, a guidance system, a safety system, processes, and methods of use that provides destination selection, deployment, confirmation, monitoring, and updates.

Another object of the disclosure is to provide a control system, a navigation system, a monitoring system, a runway incursion system, a navigation system, a guidance system, a safety system, processes, and methods of use that provides smart path recommendations.

Yet another object of the disclosure is to provide a control system, a navigation system, a monitoring system, a runway incursion system, a navigation system, a guidance system, a safety system, processes, and methods of use that provides navigation tracking.

Another object of the disclosure is to provide a control system, a navigation system, a monitoring system, a runway incursion system, a navigation system, a guidance system, a safety system, processes, and methods of use that integrate and provide safety alarms in the event of navigation error.

Yet another object of the disclosure is to provide a control system, a navigation system, a monitoring system, a runway incursion system, a navigation system, a guidance system, a safety system, processes, and methods of use that provides automation and/or creation for emergency situations.

Another object of the disclosure is to provide a control system, a navigation system, a monitoring system, a runway incursion system, a navigation system, a guidance system, a safety system, processes, and methods of use that is fully customizable to different airport needs and requirements such as airport layout and the like.

Another object of the disclosure is to provide a control system, a navigation system, a monitoring system, a runway incursion system, a navigation system, a guidance system, a safety system, processes, and methods of use that are easy to use.

Yet another object of the disclosure is to provide a control system, a navigation system, a monitoring system, a runway incursion system, a navigation system, a guidance system, a safety system, processes, and methods of use that are safe to use.

Another object of the disclosure is to provide a control system, a navigation system, a monitoring system, a runway incursion system, a navigation system, a guidance system, a safety system, processes, and methods of use that utilizes a global positioning system.

Yet another object of the disclosure is to provide a control system, a navigation system, a monitoring system, a runway incursion system, a navigation system, a guidance system, a safety system, processes, and methods of use that provides alerts.

Another object of the disclosure is to provide a control system, a navigation system, a monitoring system, a runway incursion system, a navigation system, a guidance system, a safety system, processes, and methods of use that tracks historical data.

Yet another object of the disclosure is to provide a control system, a navigation system, a monitoring system, a runway incursion system, a navigation system, a guidance system, a safety system, processes, and methods of use that can run autonomously.

Another object of the disclosure is to provide a control system, a navigation system, a monitoring system, a runway incursion system, a navigation system, a guidance system, a safety system, processes, and methods of use that are accurate.

Yet another object of the disclosure is to provide a control system, a navigation system, a monitoring system, a runway incursion system, a navigation system, a guidance system, a safety system, processes, and methods of use that works with various digital platforms.

Another object of the disclosure is to provide a control system, a navigation system, a monitoring system, a runway incursion system, a navigation system, a guidance system, a safety system, processes, and methods of use that provides a friendly user interface.

Yet another object of the disclosure is to provide a control system, a navigation system, a monitoring system, a runway incursion system, a navigation system, a guidance system, a safety system, processes, and methods of use that are quick and efficient.

Another object of the disclosure is to provide a control system, a navigation system, a monitoring system, a runway incursion system, a navigation system, a guidance system, a safety system, processes, and methods of use that are easy to program to a predetermined set of rules.

Yet another object of the disclosure is to provide a control system, a navigation system, a monitoring system, a runway incursion system, a navigation system, a guidance system, a safety system, processes, and methods of use that are robust.

Another object of the disclosure is to provide a control system, a navigation system, a monitoring system, a runway incursion system, a navigation system, a guidance system, a safety system, processes, and methods of use that saves time for a user.

Yet another object of the disclosure is to provide a control system, a navigation system, a monitoring system, a runway incursion system, a navigation system, a guidance system, a safety system, processes, and methods of use that saves energy.

Another object of the disclosure is to provide a control system, a navigation system, a monitoring system, a runway incursion system, a navigation system, a guidance system, a safety system, processes, and methods of use that are high quality.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a diagram illustrating the pushback system; the diagram showing terminals, pushback lanes, pushback key locations, among other features.

FIG. 2 is a diagram illustrating the pushback system; the diagram showing terminals, pushback lanes, pushback key locations, among other features.

FIG. 3 is a diagram illustrating the pushback system; the diagram showing terminals, pushback lanes, pushback key locations, among other features.

FIG. 4 is a diagram illustrating the pushback system; the diagram showing terminals, pushback lanes, pushback key locations, among other features.

FIG. 5 is a diagram illustrating the pushback system; the diagram showing terminals, pushback lanes, pushback key locations, among other features.

FIG. 6 is a diagram illustrating the system; the diagram showing interactions between different key components of the system and different base components.

FIG. 7 is a diagram illustrating the interaction of the main components of the system; each system having integrations with a graphical user interface; each system being shown operating independently but also in concert with one another.

FIG. 8 is a diagram illustrating the navigation system; the diagram showing various functionality and components of the navigation system.

FIG. 9 is a diagram illustrating the emergency system; the diagram showing various functionality and components of the emergency system.

FIG. 10 is a continuation of FIG. 9, showing a diagram illustrating the emergency system; the diagram showing various functionality and components of the emergency system.

FIG. 11 is a diagram illustrating additional features of the navigation system; the diagram showing various additional functionality and additional components of the system.

FIG. 12 is a diagram illustrating the briefing system; the diagram showing different briefing points and associated functionality of the briefing and debriefing system.

FIG. 13 is a diagram illustrating the vertical takeoff system; the diagram showing different components and associated functionality of the vertical takeoff system.

FIG. 14 is a diagram illustrating the pushback system; the diagram showing various functionality and components of the pushback system.

FIG. 15 is a diagram illustrating alternative embodiments of the system.

FIG. 16 is a diagram illustrating various computer related components, but not limited to these components, of those of the system.

FIG. 17 is a diagram illustrating emergency management functionality of the system.

FIG. 18 is a continuation of FIG. 17.

FIG. 19 is a diagram illustrating navigation features associated with the system.

FIG. 20 is a continuation of FIG. 19.

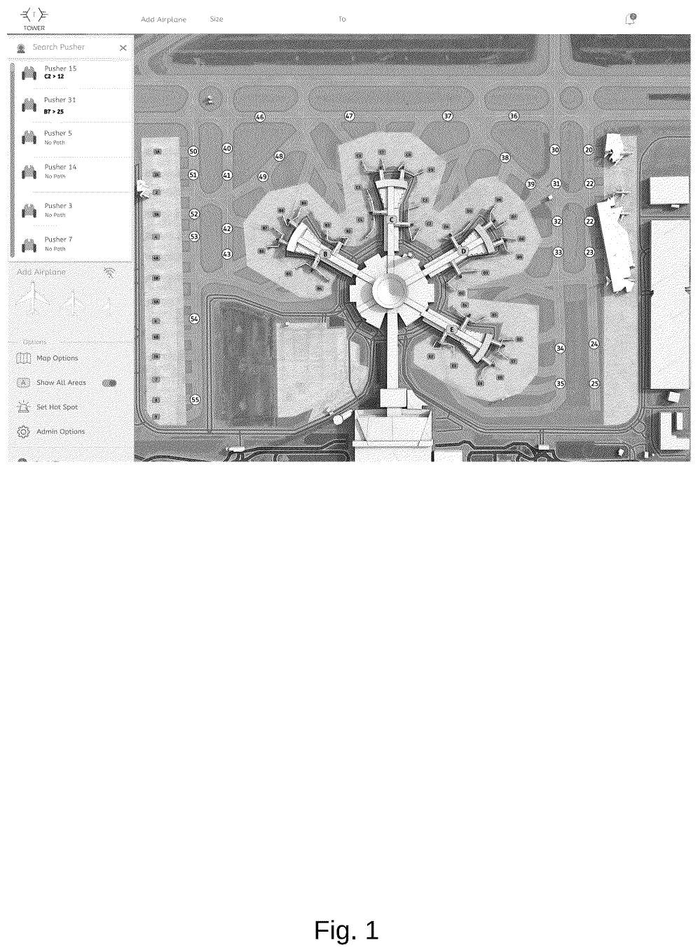

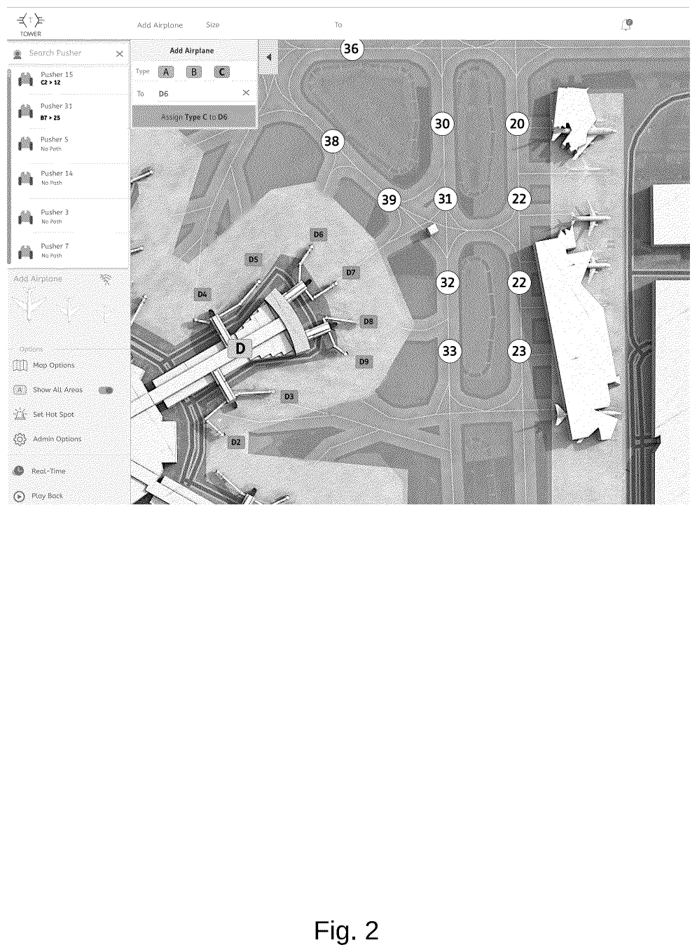

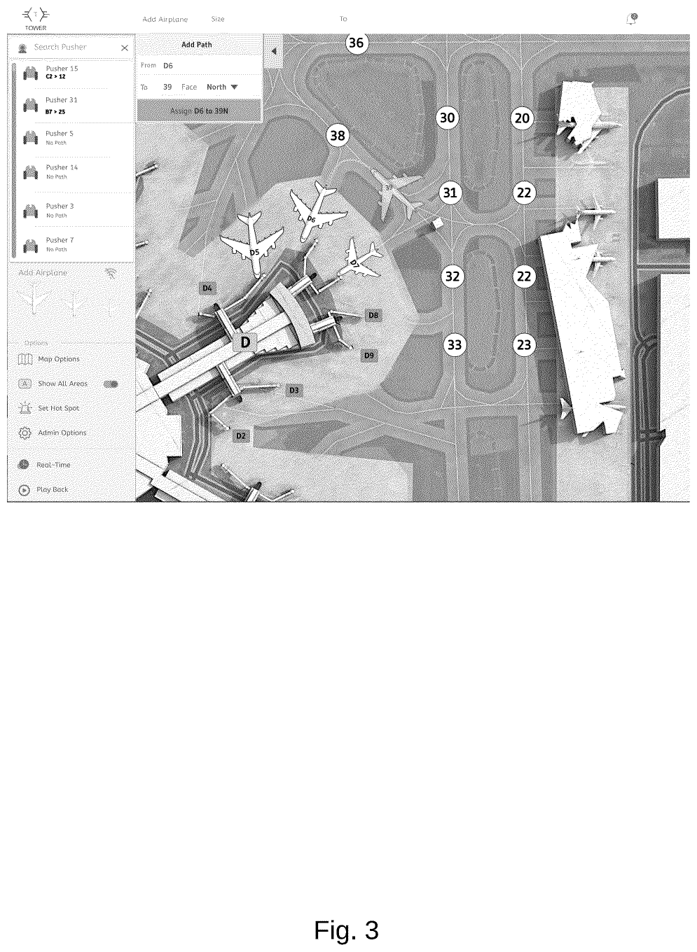

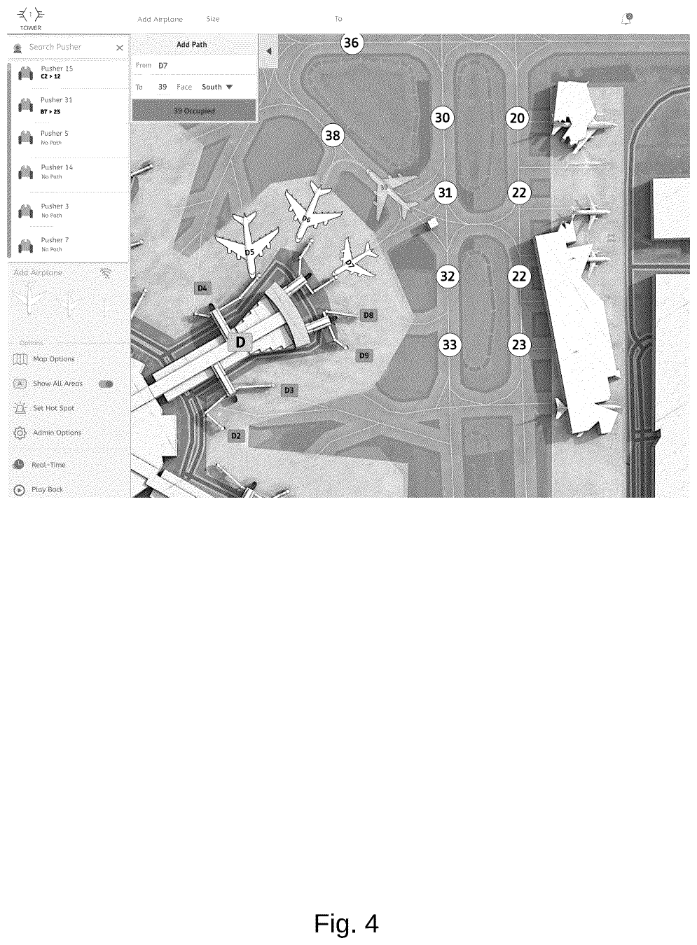

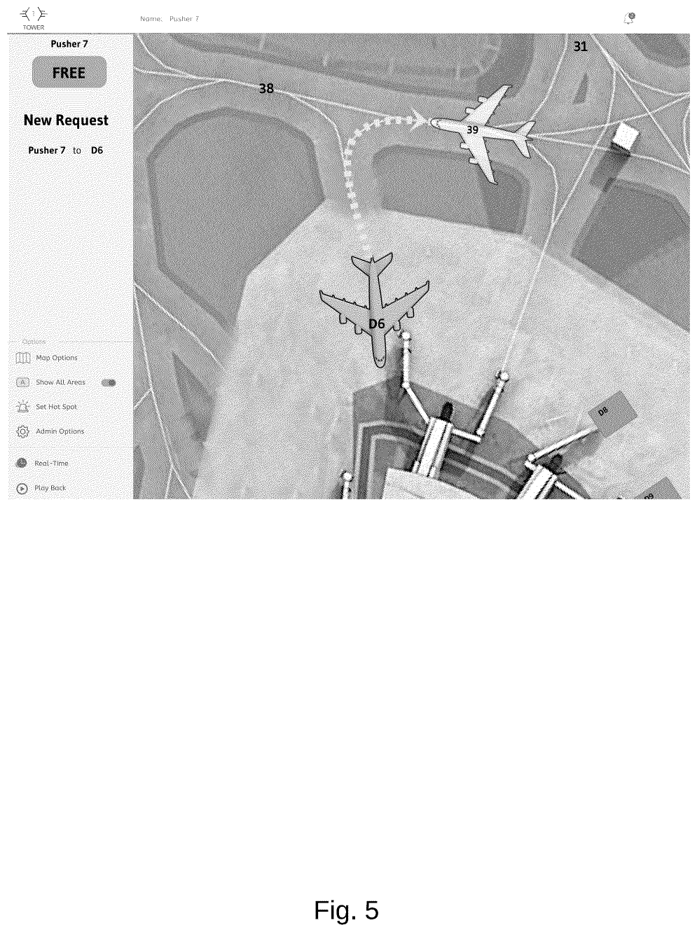

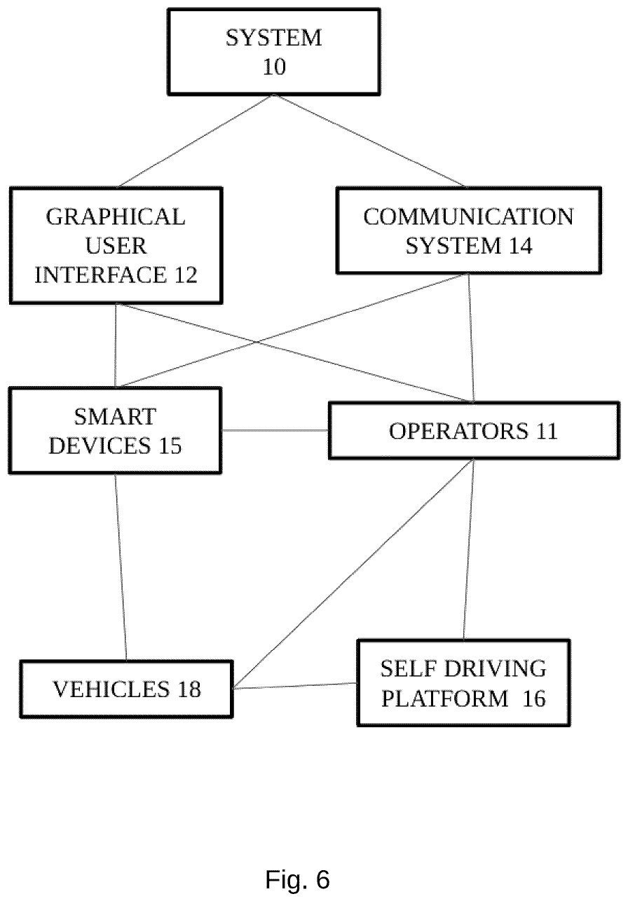

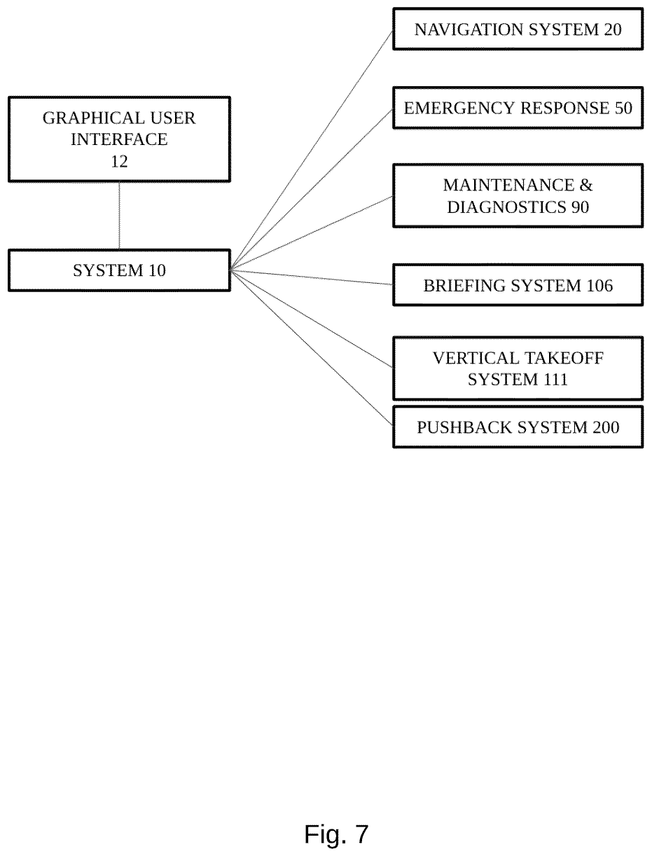

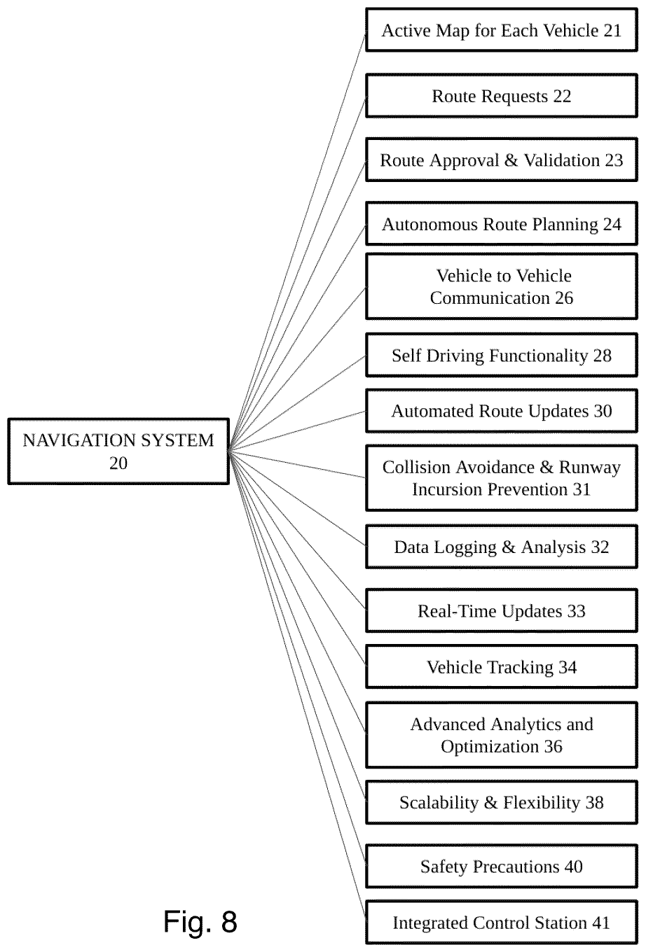

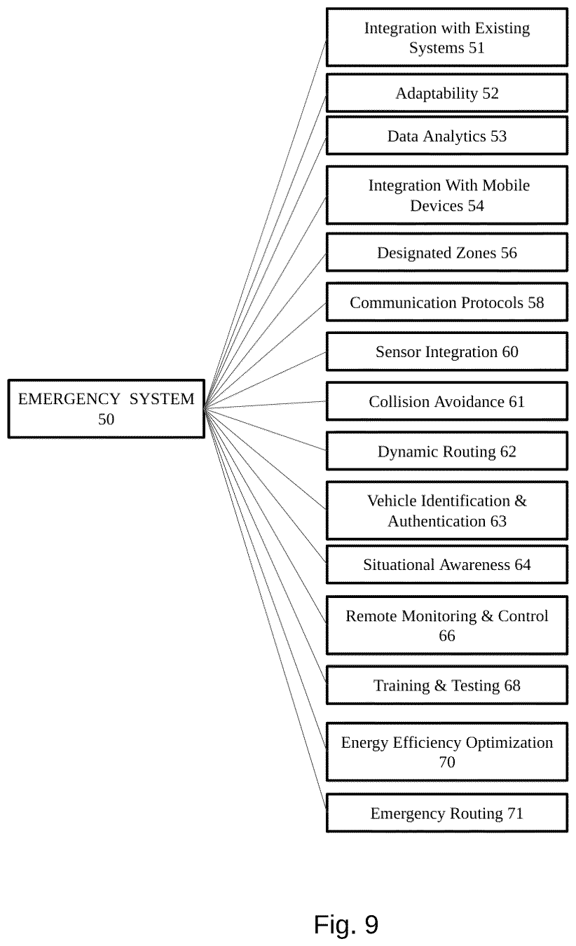

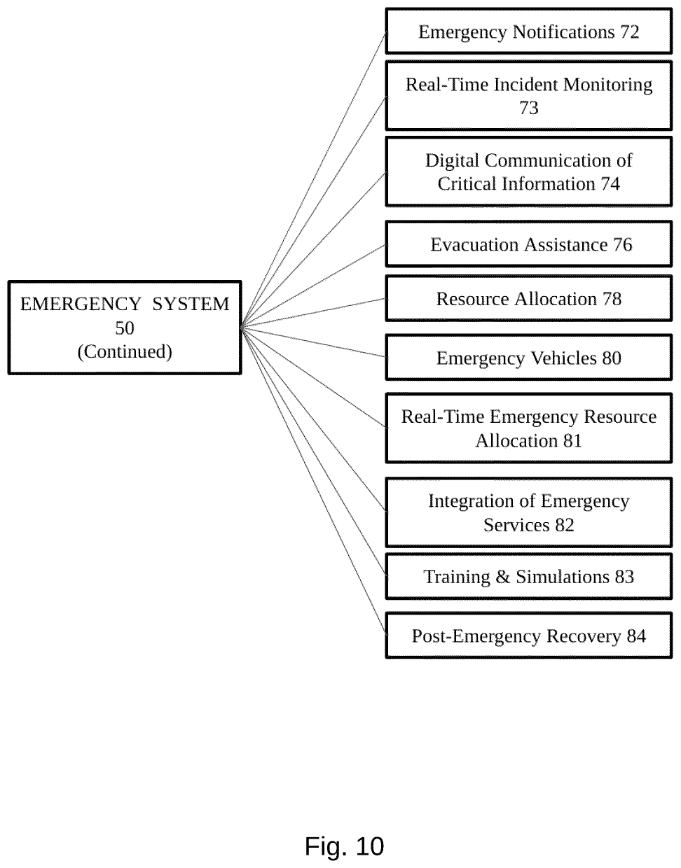

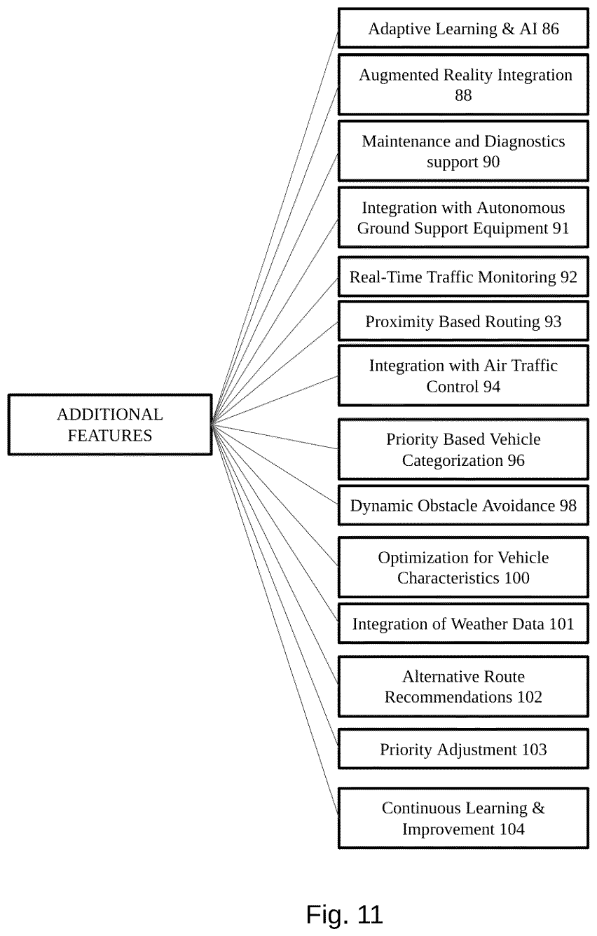

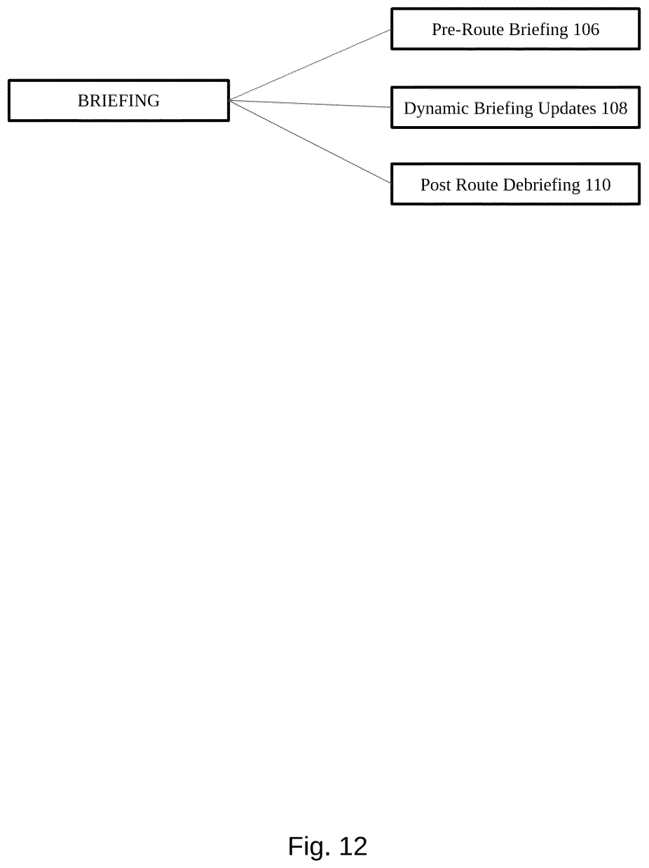

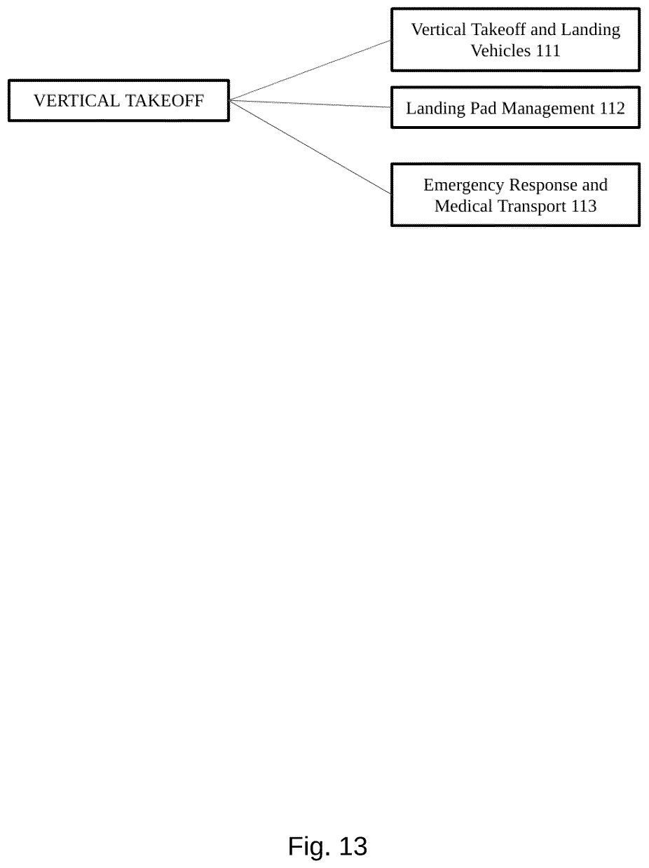

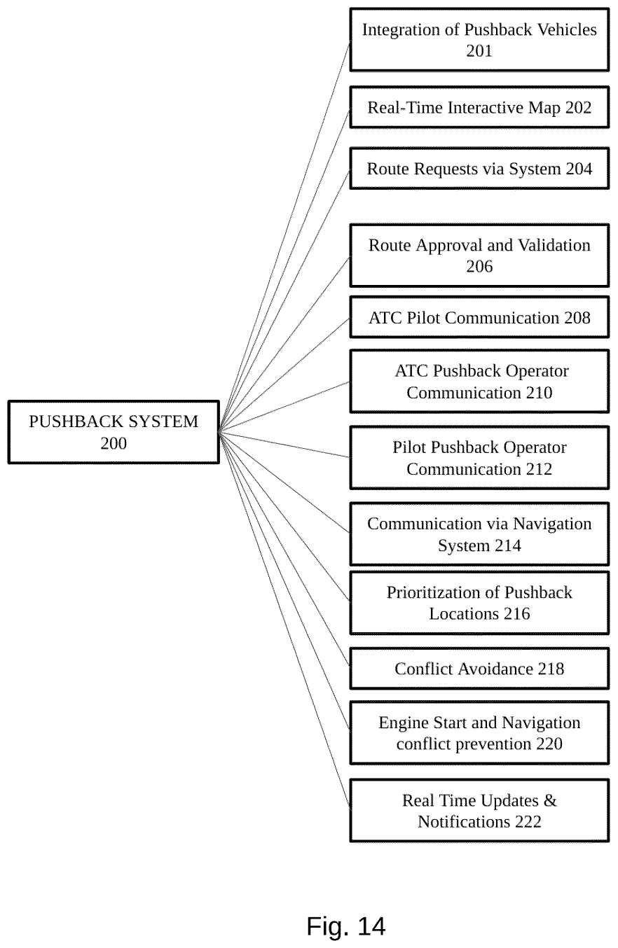

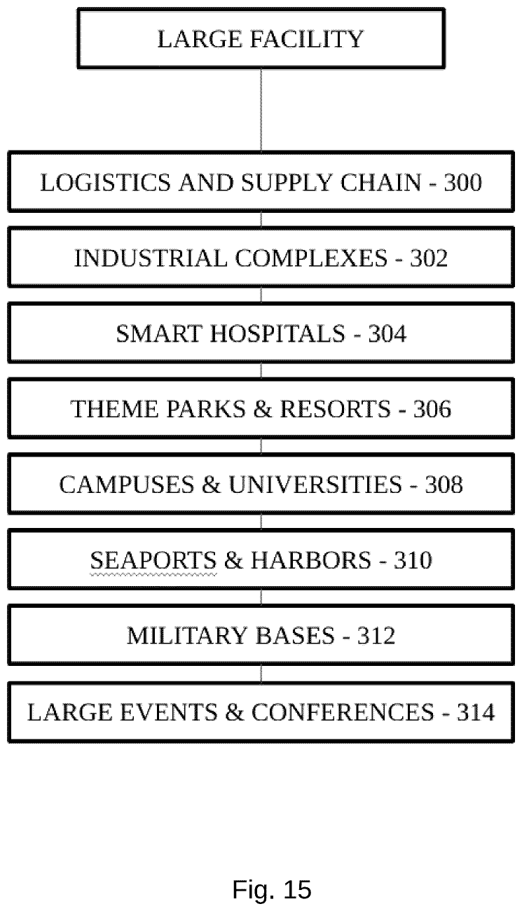

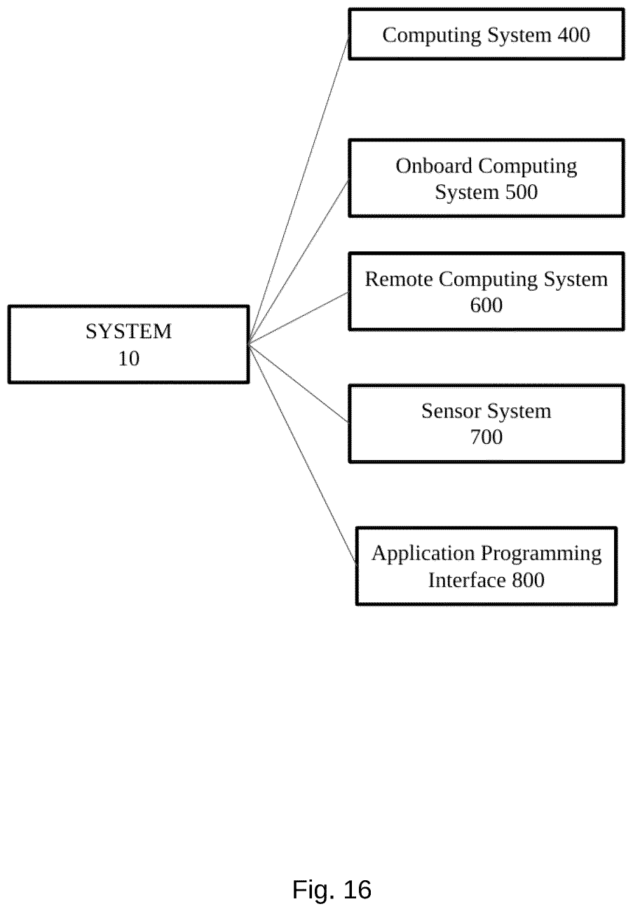

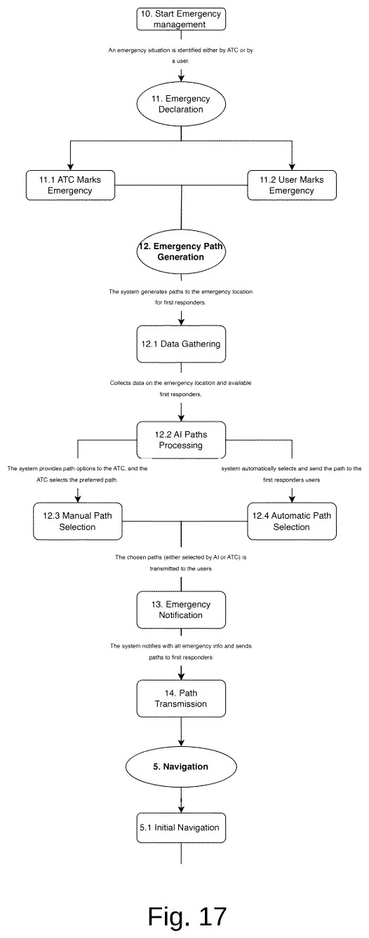

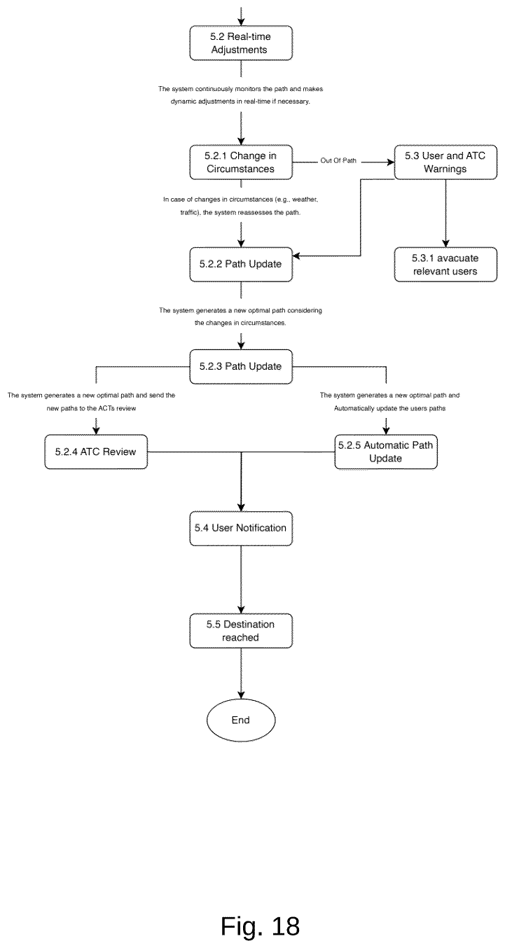

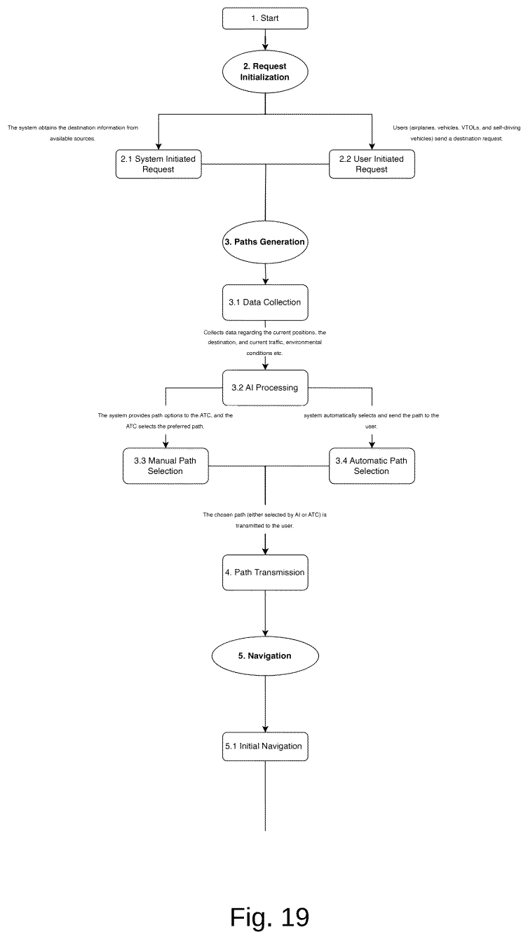

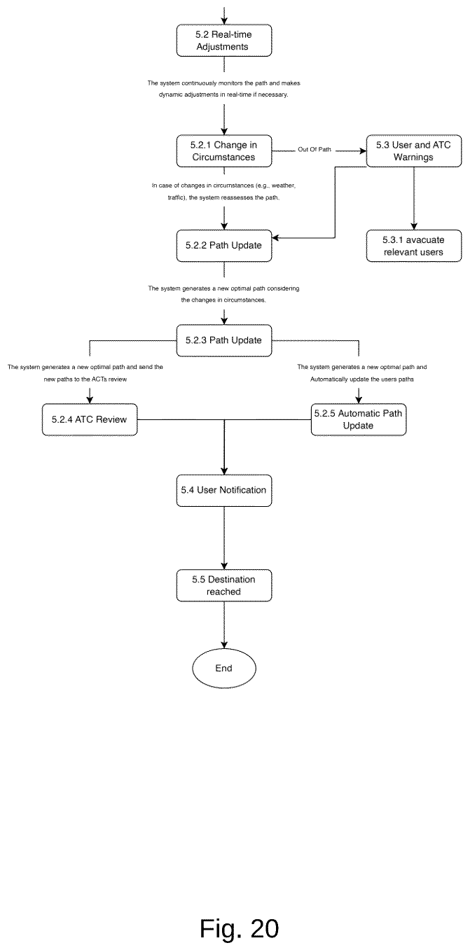

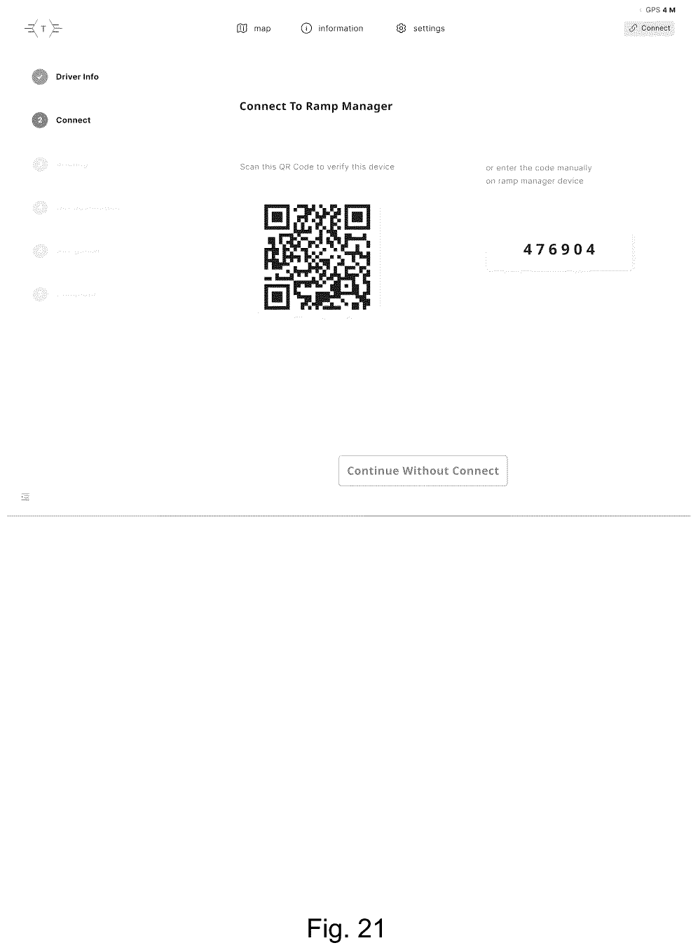

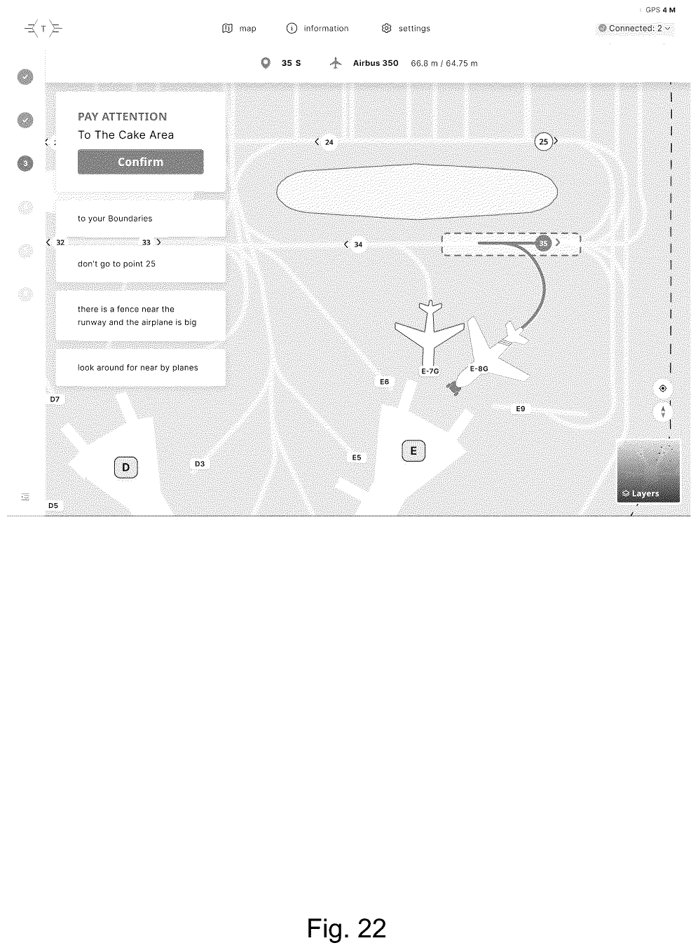

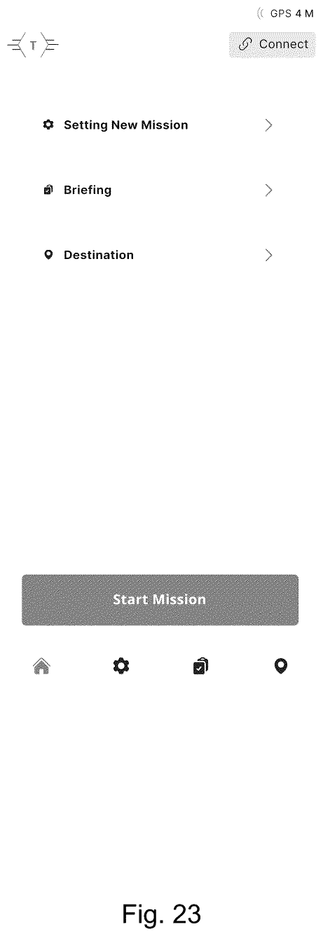

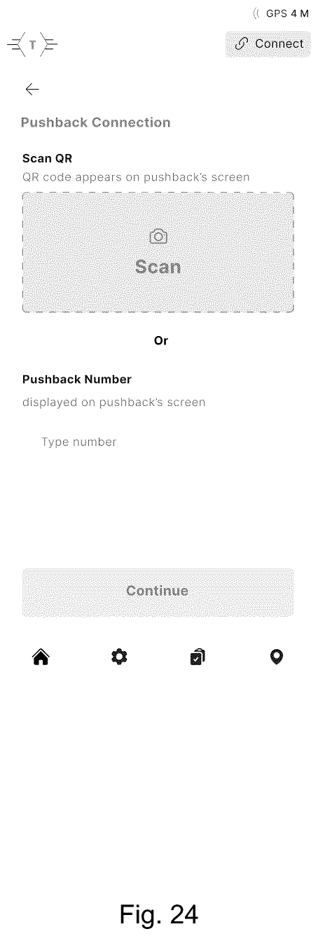

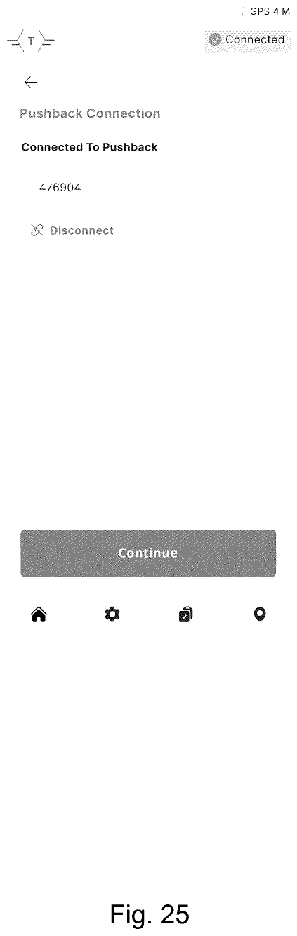

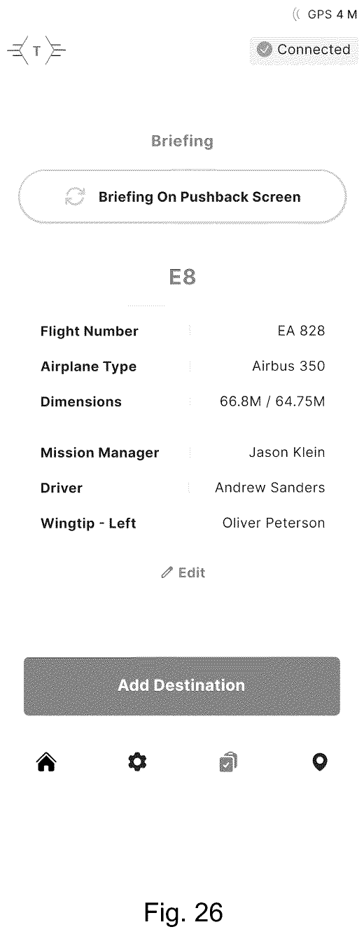

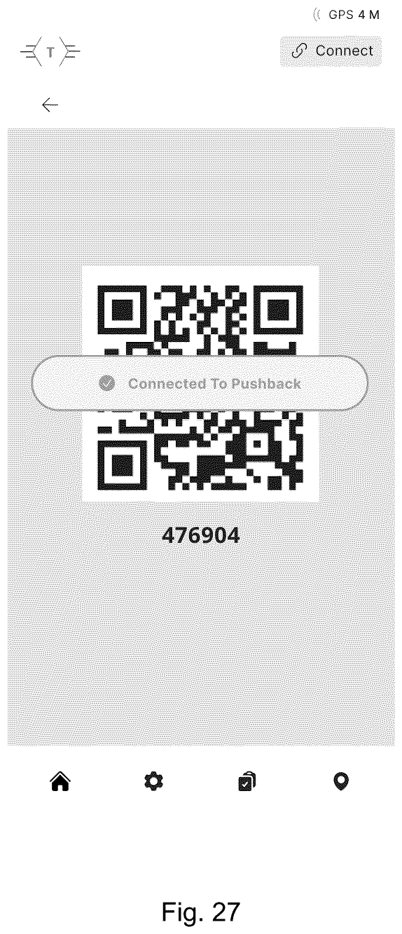

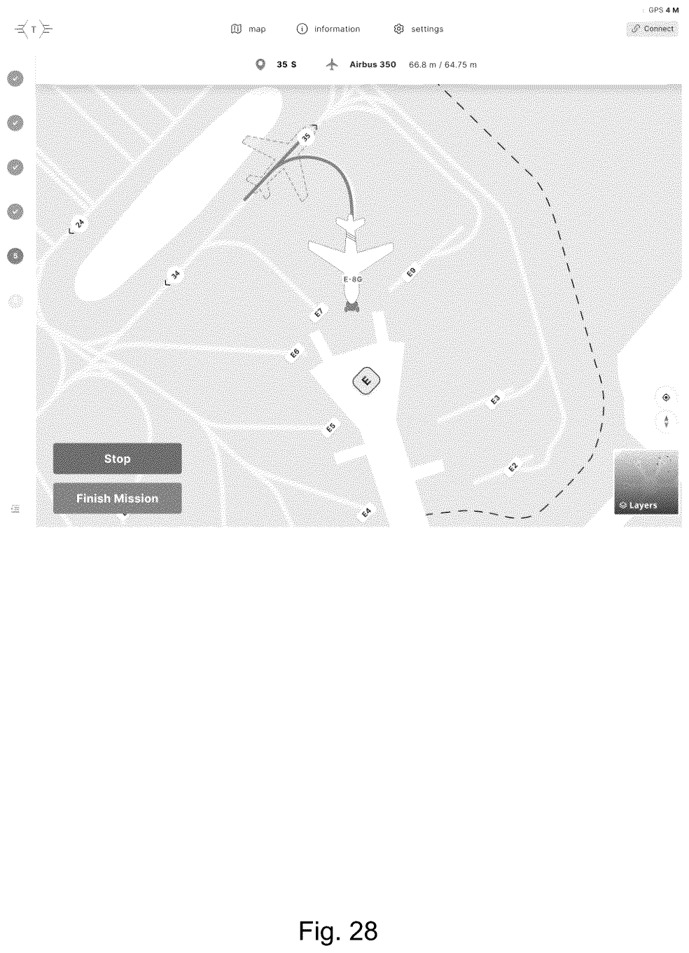

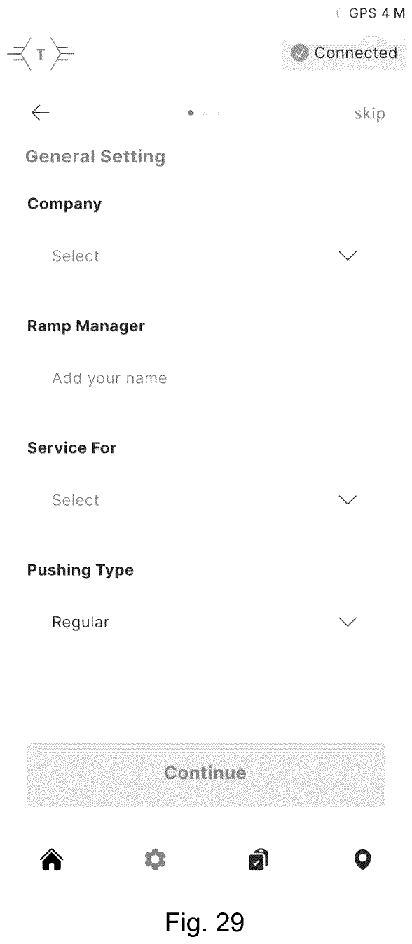

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

### System:

With reference to the figures, a control system, a navigation system, a monitoring system, a runway incursion system, a navigation system, a guidance system, a safety system, processes, and methods of use 10 are presented. Control system, a navigation system, a monitoring system, a runway incursion system, a navigation system, a guidance system, a safety system, processes, and methods of use 10 (hereafter referred to as “navigation system”, “tower link system”, “control and monitor system”, “fleet management”, or simply “system”) is formed of any suitable size, shape and design.

In the arrangement shown, navigation system 10/20 is configured to provide a plurality of services, which integrate and overlap. In the arrangement shown, as one example, navigation system 20 includes a control and monitoring feature. In this way, the navigation system provides fleet monitoring. Furthermore, the system includes integration features for integrating the system into existing systems and/or facilities.

In the arrangement shown, as one example, navigation system 20 is configured to provide a quick and advanced way for taxiing a fleet. Said another way, navigation system 10 provides various functionalities, as will be described further herein such that landing, taking off, taxiing, and the like can be managed in a more efficient and safe manner.

Furthermore, navigation system 20 reduces controller (air traffic controller) workload. Navigation system 20 takes over the handling of monitoring and/or assigning multiple movements throughout a facility and confirms that the assigned pathways are actually taking place in accordance with the clearances of the system. By taking the assignments and monitoring into computer programming and utilizing global positioning systems, the present disclosure eliminates human errors and provides for monitoring that actual instructions are being executed correctly. Said another way, the present disclosure includes a collision avoidance and runway incursion prevention feature 31.

For example, when a human air traffic controller assigns a waypoint, or taxi path for a recently landed aircraft, the aircraft then takes that taxiing path to a terminal. In assigning the waypoint, the air traffic controller has hopefully evaluated correctly that no incursions will occur with other runways, other landings, other planes, other airport vehicles such as fueling vehicles, buses, and the like. Furthermore, once an air traffic controller assigns a waypoint, the controller does not verify that the waypoint is actually executed at every turn. Navigation system 20 monitors all vehicles and can assign smart waypoints for the most efficient and safe manner of execution. Furthermore, Navigation system 20 continues to monitor the assigned waypoint and if a wrong turn is made by an aircraft, and/or the aircraft (or vehicle) deviates from the assigned waypoint, then an alert is sent to both the pilot (or driver) and the controller. The pilot can then correct and/or the controller can then instruct the pilot to correct and/or change the course of the aircraft (or vehicle). This control and monitoring feature dramatically improves logistics of a large facility and reduces controller workload. Furthermore, this functionality greatly increases safety while reducing runway incursions.

Runway incursions are defined as any occurrence at an airport or large facility where the incorrect presence of an aircraft, vehicle, or person occurs. Incursions also include a protected area such as a surface designated for landing and/or a takeoff and the like.

In the arrangement shown, as one example, system 10 may comprise remote servers, databases, application servers, application databases, product databases, mobile applications, and/or computers; all of which in continuity or as separate acts fulfill the functions disclosed herein. System 10 also includes, in the embodiment(s) depicted, a user 11, a graphical user interface 12, a communication system 14, a plurality of smart devices 15, a self-driving platform 16, a plurality of vehicles 18, a computing system 400, an onboard computing system 500, a remote computing system 600, a sensor system 700, and an application programming interface 800, a communication and/or control system, and a mobile computing application, among other components, features, and functions.

Furthermore, and in the arrangement shown, as one example, system 10 includes an active map for each vehicle 21, a route requests feature 22, a route approval and validation feature 23, an autonomous route planning feature 24, a vehicle to vehicle communication system 26, a self-driving functionality feature 28, an automated route update feature 30, a collision avoidance and runway incursion prevention feature 31, a data logging and analysis feature 32, a real-time update feature 33, a vehicle tracking feature 34, an advanced analytics and optimization feature 36, a scalability and flexibility feature 38, a safety precautions feature 40, an emergency response system 50, an integration with existing feature 51 of the emergency response system 50, an adaptability feature 52, a data analytics feature 53, an integration with mobile devices feature 54, a designated zones feature 56, a communication protocol features 58, a sensor integration feature 60, a collision avoidance feature 61, a dynamic routing feature 62, a vehicle identification and authentication feature 63, a situational awareness feature 64, a remote monitoring and controlling feature 66, a training and testing feature 68, an energy efficiency optimization feature 70, an emergency routing feature 71, an emergency notifications feature 72, a real-time incident monitoring feature 73, a digital communication of critical communication feature 74, an evacuation assistance feature 76, a resource allocation feature 78, a real-time emergency resource allocation feature 81, an integration of emergency services feature 82, a training and simulations feature 83, a post-emergency recovery feature 84, an adaptive learning and integration feature 87, an augmented reality integration feature 88, a maintenance and diagnostics support feature 90, an integration with autonomous ground support equipment feature 91, a real-time traffic monitoring feature 92, a proximity based routing feature 93, an integration with air traffic control feature 94, a priority based vehicle categorization feature 96, a dynamic obstacle avoidance feature 98, an optimization for vehicle characteristics feature 100, an integration of weather data feature 101, an alternative route recommendations feature 102, a priority adjustment feature 103, a continuous learning and improvement feature 104, a pre-route briefing feature 106, a dynamic briefing updates feature 108, a post route debriefing 110, a vertical takeoff and landing vehicles system 111, a landing pad management system 112, an emergency response and medical transport feature 113, among other components, features, and functions.

In the arrangement shown, as one example, system 10 also includes an integrated pushback vehicle system 200. Integrated pushback vehicle system 200, includes but not limited to, a real-time interactive map 202, a route requests feature 204, a route approval and validation feature 206, an ATC pilot communication feature 208, an ATC pushback operator communication feature 210, a pilot pushback operator communication feature 212, a communication via navigation system feature 214, a prioritization of pushback location feature 216, a conflict avoidance feature 218, an engine start and navigation conflict prevention feature 220, and a real-time updates and notifications feature 222, among other components, features, and functions.

In the arrangement shown, as one example, system 10 may also include and/or include in the alternative a logistics and supply chain system 300, an industrial complex system 302, a smart hospital system 304, a theme park and resort system 306, a campuses and universities system 308, a seaports and harbors system 310, a military base system 312, a large events and/or conference system 314, and the like.

While modern airports use radio frequency for communication between control towers, pilots, vehicles, emergency vehicles and other vehicles moving about an airport (whether inside or outside), the present disclosure provides a new system which is unique to airport navigation and safety.

Said another way, the present disclosure reduces and/or eliminates the need for radio communication, which can be unreliable, dangerous and extremely cumbersome. Furthermore, the present system provides integration of movement of self-driving platforms alongside human operated ones in modern logistics through providing a full solution throughout a fleet management system for normal, training and emergency procedures.

### User (or Plurality Thereof):

In the arrangement shown, as one example, system 10 includes a user. User 11, also known as operator and/or controller, may be any user interacting with or utilizing the system 10. This may include viewing, controlling, analyzing, manipulating, and/or interacting with system 10. User 11 is not limited to a single user but may be a plurality of users. In the arrangement shown, as one example, a user may be an air traffic controller, an air pilot, a vehicle driver, emergency personnel, airport personnel, programmers, drivers, pilots, and the like

### Graphical User Interface:

In the arrangement shown, as one example, system 10 may include a graphical user interface 12. Graphical user interface 12 is formed of any suitable size shape and design and is configured to allow a user to view interact with, manipulate, and visually access system data and information, information related thereto, and/or view various data for various environments and/or add information to system and/or environment and/or change the settings of the sensors and/or change the settings of operation.

Graphical user interface 12 is an exemplary method by which systems of the present disclosure may operate and/or make programming changes to the operation of system 10. Employing graphical user interface 12, enhances a user's interactions with system 10 in the form of awareness and knowledge of data within the system 10. System 10 provides direct links to a user's history, settings, programming, and other information related to a particular function and/or a particular component and/or a particular user and/or a particular operation. In this way graphical user interface 12 provides for a means for a user to make adjustments to the operation and functionality of system 10.

### Display of Graphical User Interface:

In the arrangement shown, as one example, system 10 includes a graphical user interface 12. Graphical user interface 12 may include a display, which is configured to show and display information, including data, for review and interpretation by a user or plurality of users, or a plurality of users interacting with one another.

In the arrangement shown, as one example, an interactive user display is formed of a display screen, such as that of a desktop computer, laptop computer, monitor, tablet, smart phone, smart TV, projector, virtual reality display or any other device or form of a display.

In the arrangement shown, as one example, interactive user display comprises a series of interactive user display pages, however, the interactive user display may consist of a single page or any other method of displaying information on a display as could be adapted to various size screens, devices, or user preferences. The interactive user display can display various information and/or functional information which is retrieved and/or requested.

### Integrated Control Station:

In the arrangement shown, as one example, system 20 includes an integrated control station 41. Integrated control station 41 is formed of any suitable size, shape, and design and is configured to provide ergonomic human engineering and interaction with the system. Integrated control station 41 may include a touch screen design with added free digital handwriting which gives an operator and/or controller full control over the airport traffic through notifications and smart interactions and the like. Furthermore, integrated control station 41 may include a plurality of screens and/or displays which provide various information and interactions, in real time.

In the arrangement shown, as one example, the integrated control station 41 may be a stand alone computing platform such as a single touchscreen or tablet which can be taken on the go or moved about with a minimal footprint. This is helpful during an implementation process and the like.

### Personal Portable Station:

System 20 may also include a personal portable station 42. Personal portable devices and/or station 42 is designed for the ease of driver use. Personal portable stations and/or devices may be a smart phone and/or other device which allows a user and/or vehicle driver (or pilot) to make requests for a path, to get gps navigation and guidance and follow a prescribed waypoint, see location, see destination, such as where a specific terminal is or a fueling station is, and the like.

Waypoint or Route: In this way, a user can request a waypoint, select a desired waypoint, send notifications of confirming a waypoint, and follow that waypoint. In the arrangement shown, waypoint 17 is also known as a route and/or path 17.

Similarly, and furthermore, during navigation tracking the navigation system provides a user with warnings and/or notifications if a route has been obstructed, if the user has strayed off path, and the like. This also includes re-routing features and more (such as in emergency situations).

User-Friendly Interface: The interface present herein is configured to be user-friendly and easy to understand, catering to both experienced and new users. The user interfaces disclosed herein include features, but are not limited to features, having visual cues, voice commands, and clear instructions for guiding the drivers and pilots effectively.

### Navigation System:

In the arrangement shown, as one example, the present disclosure provides a modern and unique navigation system 20 which dramatically improves upon efficiency, safety, and efficacy in airport logistics.

Active Map for Each Vehicle: In the arrangement shown, as one example, the navigation system 10 provides a real-time, interactive map for each vehicle 21, displaying its current position, intended route, surrounding vehicles, and relevant airport infrastructure. In this way, the interactive map is accessible from the vehicle's onboard display or a dedicated device, providing for the operator to have a clear visual representation of the airport environment in real-time.

In the arrangement shown, as one example, each vehicle includes an interactive map. However, not all vehicles at a facility or in a geographic area may include an interactive map. This is especially true during some integration processes, and the like.

Route Requests via the System: In the arrangement shown, as one example, the navigation system 10 provides operators would have the option to submit route requests 22 through the navigation system. This differs dramatically from systems currently available in the art because the current art operates through air controllers at a centralized location giving orders through radio communication. No options are available in the current state of the art for which a pilot or other vehicle can make decisions based on options.

In this way, and as shown in one example, an operator inputs the desired destination or specific waypoints, and the system calculates and proposes the most efficient route and/or route options based on factors like aircraft type, runway availability, and taxiway congestion, and more.

Route Approval and Validation: In the arrangement shown, as one example, the navigation system 10 provides a communication system for receiving, approving and validating route requests and/or automatically validating 23 route requests against various criteria, such as airspace restrictions, active runways, and ongoing ground operations, and the like.

The system considers factors such as, but not limited to, aircraft size, weight, and type-specific limitations to ensure safe and feasible routes. Once approved, the system would transmit the route instructions back to the requesting vehicle.

Automated Route Planning: In the arrangement shown, as one example, the navigation system 10 provides for autonomous route planning 24 or automatically generating, based on a predetermined set of rules and learned rules, optimal routes for vehicles based on their destinations, taking into account factors like runway availability, traffic congestion, and priority access for emergency vehicles, and the like. In this way, the system integrates various information otherwise not considered by controllers which streamlines operations and reduces delays.

Vehicle-to-Vehicle Communication: In the arrangement shown, as one example, the navigation system 10 provides vehicle to vehicle communication 26. In other words, system 10 provides vehicles equipped with the navigation system which are able to detect, locate and/or communicate with each other; sharing positions, intentions-such as route planning and waypoints, and other relevant information. In this way, coordination is streamlined for efficient coordination, collision avoidance, and smooth traffic flow.

### Self-Driving Capability:

In the arrangement shown, as one example, the navigation system 10 provides integration for both manual and self-driving vehicles 28 and/or self-driving functionality 28; as might be available at a location at the time of integration and/or may be implemented over time.

Furthermore, and in the arrangement shown, as one example, the navigation system 10 provides an interface for manual drivers while also facilitating autonomous operations for designated areas and/or specific tasks, such as maintenance or baggage handling. Safety protocols, including fail-safe mechanisms are drastically improved and are crucial for autonomous operations.

### Automated Route Updates:

In the arrangement shown, as one example, the navigation system 10 provides automated route updates 30. This is extremely beneficial and advantageous in unexpected events, such as runway closures, changing weather conditions, or operational changes, the navigation system would dynamically update the routes for affected vehicles.

In this way, these updates are communicated directly to the vehicles, ensuring they have the most up-to-date information and routes of the vehicles and/or waypoints are adjusted accordingly, in real-time.

### Collision Avoidance and Runway Incursion Prevention 31:

In the arrangement shown, as one example, the navigation system 10 provides an active map feature and route guidance features including the navigation system planning for collision avoidance through speed and timing integration features which provide runway incursion prevention; a key functionality for airport safety.

In this way, the system continuously monitors the positions of all vehicles, crosscheck with known runway and taxiway locations, and issue warnings or alerts if potential conflicts or incursions and/or other detections of concern. This proactive approach prevents accidents and dramatically improves overall safety of these facilities, airports, users, and the like.

### Data Logging and Analysis 32:

In the arrangement shown, as one example, the navigation system 10 provides ongoing real-time log data related to route requests, approved routes, and actual vehicle movements. This data can then be used for post-event analysis, performance evaluation, and identifying areas for improvement, and ongoing rule learning and rule implementation. Said another way, the data logging and analysis feature contributes to the development of machine learning algorithms to enhance the system's route planning capabilities over time.

### Real-Time Updates 33:

In the arrangement shown, as one example, the navigation system 10 provides integration with airport management systems to receive real-time updates on flight schedules, gate changes, runway closures, weather conditions, emergency situations and maintenance activities. This information can be used to optimize routes and minimize delays or conflicts. In this way, the real-time updates features ensure timely responses and improve safety of airport operations.

### Vehicle Tracking 34:

In the arrangement shown, as one example, the navigation system 10 provides an implementing tracking feature which actively monitors the location and status of vehicles within the airport premises. This information is utilized by the system to enhance safety and coordination, particularly during emergencies.

### Advanced Analytics and Optimization 36:

In the arrangement shown, as one example, the navigation system 10 provides collecting and analyzing data from various sources, the system could identify patterns, optimize vehicle routing, and make predictions to improve overall efficiency. This includes, but is not limited to, fuel optimization, reducing congestion, and minimizing environmental impact.

### Scalability and Flexibility 38:

In the arrangement shown, as one example, the navigation system 10 provides functionality which can be designed, adjusted, and the like to accommodate airport expansions, changes in infrastructure, and technological advancements.

Said another way, the system is scalable to handle growing traffic demands and flexible to adapt to future requirements, through settings in the system by a predetermined set of rules.

Safety Precautions 40: In the arrangement shown, as one example, the navigation system 10 provides incorporation of various safety precautions, such as speed limits and restricted areas. In this way, the system assigns and adjusts in real-time to prevent accidents and maintain a secure environment within the airport.

### Emergency Response 50:

In the arrangement shown, as one example, the navigation system 10 provides an emergency response system 50. In this way, in the event of an emergency, the system provides emergency response teams (e.g., ambulances, fire trucks) at the absolute fastest and safest routes for reaching the affected areas. In this way, the system ensures a rapid and efficient response to an emergency no matter where the emergency is occurring.

Furthermore, emergency response system also includes an integration feature 51 for integration of the emergency response system with existing system. Furthermore, system 10 incorporates emergency response planning, including predefined routes and procedures for emergency vehicles. In this way, the system factors in critical response times and coordinates with relevant authorities to ensure swift and efficient emergency management within the airport premises.

The emergency response system 50 may also include a plurality of emergency response vehicles 80. Emergency response vehicles 80 include but are not limited to fire trucks, police vehicles, tankers, ambulances, and other emergency vehicles, and the like.

### Emergency Routing 71:

In the arrangement shown, as one example, the navigation system 10 provides optimized emergency routes 71 for vehicles responding to different types of emergencies, such as medical emergencies, fires, or security incidents. The system considers real-time data, traffic conditions, and potential hazards to guide emergency vehicles swiftly and safely to the incident location.

### Emergency Notifications 72:

In the arrangement shown, as one example, the navigation system 10 integrate the navigation system with an alert system and alert system features to quickly disseminate emergency notifications to airport personnel, passengers, and relevant stakeholders. In this way, the system includes instructions for evacuation, sheltering, or any specific actions required during different emergency scenarios.

Integration with Existing Systems 51:

In the arrangement shown, as one example, the navigation system 10 provides integrating the navigation system with various airport systems, such as air traffic control and ground traffic management systems. This integration optimizes overall operations and improves communication between various stakeholders.

### Adaptability 52:

In the arrangement shown, as one example, the navigation system 10 provides adaptation features to changing airport layouts, expansions, and renovations. This flexibility ensures that the navigation system remains accurate and reliable over time.

### Data Analytics 53:

In the arrangement shown, as one example, the navigation system 10 provides collecting and analyzing data and/or collecting features and/or analyzing features from the navigation system in order to provide valuable insights for optimizing airport operations, identifying bottlenecks, and improving overall efficiency; in an ongoing basis and in an ongoing rapid change format to keep integrations and operations optimal in real-time.

Integration with Mobile Devices 54:

In the arrangement shown, as one example, the navigation system 10 provides a mobile application version of the navigation system which allows airport personnel to access it conveniently on their smartphones or tablets.

### Designated Zones 56:

In the arrangement shown, as one example, the navigation system 10 provides specific zones within an airport where self-driving vehicles and/or robots are permitted to operate. These zones can be designated based on factors such as traffic flow, safety considerations, and the type of vehicles/robots involved.

### Communication Protocols 58:

In the arrangement shown, as one example, the navigation system 10 provides development of standardized communication protocols that enable self-driving vehicles/robots to interact with the navigation system and other vehicles in real-time. In this way, the features of the communication protocols system include sharing information about their intended routes, speed, and any planned maneuvers.

### Sensor Integration 60:

In the arrangement shown, as one example, the navigation system 10 and sensor system ensure that self-driving vehicles and/or robots are equipped with advanced sensors, such as lidar, radar, and cameras, to detect and avoid obstacles, pedestrians, and other vehicles. The navigation system can integrate with these sensors to provide real-time data and enhance overall safety.

### Collision Avoidance 61:

In the arrangement shown, as one example, the navigation system 10 provides implementation of collision avoidance algorithms that enable self-driving vehicles/robots to detect and respond to potential collisions. In this way, the system integrates automatic braking, lane adjustments, or route reconfigurations to prevent accidents and ensure smooth traffic flow, as needed.

### Dynamic Routing 62:

In the arrangement shown, as one example, the navigation system 10 provides a dynamic routing feature which optimizes the movement of both self-driving and manual driving vehicles within the airport. In this way, the system analyzes and processes various factors such as traffic congestion, real-time data updates, and prioritizing emergency vehicles when necessary.

### Vehicle Identification and Authentication 63:

In the arrangement shown, as one example, the navigation system 10 provides a secure system for authenticating and identifying self-driving vehicles and/or robots, ensuring that only authorized entities can access and operate within the airport. In this way, a very secure system such as airports is maintained, controlled and secure.

### Situational Awareness 64:

In the arrangement shown, as one example, the navigation system 10 provides a situational awareness feature for self-driving vehicles and/or robots which share information about surrounding vehicles, pedestrians, construction zones, or other potential hazards.

### Remote Monitoring and Control 66:

In the arrangement shown, as one example, the navigation system 10 provides implementing remote monitoring and control capabilities to oversee the operations of self-driving vehicles and/or robots. In this way, system 10 provides human operators to intervene if necessary, ensuring safety and resolving any issues that may arise.

### Training and Testing 68:

In the arrangement shown, as one example, the navigation system 10 provides comprehensive training programs and testing environments for self-driving vehicle and/or robot operators to ensure they understand the navigation system, its protocols, and emergency procedures. Furthermore, the training and testing feature includes regular evaluations and updates can help maintain a high standard of safety and efficiency.

### Energy Efficiency Optimization 70:

In the arrangement shown, as one example, the navigation system 10 provides optimization of routing of airport vehicles, considering factors such as energy consumption and emissions. In this way, the system contributes to the airport's sustainability efforts and reduces impact on the environment.

### Real-Time Incident Monitoring 73:

In the arrangement shown, as one example, the navigation system 10 integrates with surveillance cameras and other sensor networks to provide real-time monitoring of critical areas within the airport. In this way, the present disclosure provides emergency management personnel to quickly identify and respond to incidents as they unfold. Furthermore, in this way, digital Communication of critical information, such as nature and location of the emergency, to emergency personnel and external responders is provided by system 10.

### Evacuation Assistance 76:

In the arrangement shown, as one example, the navigation system 10 provides evacuation guidance to vehicles, self-driving platforms, passengers and personnel during emergencies. In this way, system 10 includes visual cues, audio instructions, and real-time updates on safe evacuation routes, assembly points, and emergency exits.

### Resource Allocation 78:

In the arrangement shown, as one example, the navigation system 10 provides a resource management feature which provides and/or assists emergency managers in allocating resources effectively during crisis situations. In this way, the system can act by instructing with information related to real-time tracking of available personnel, equipment, and emergency supplies within the airport.

### Real-Time Emergency Resource Allocation 81:

In the arrangement shown, as one example, the navigation system 10 provides a dynamic allocation of emergency resources 81. Said another way, the system dynamically allocates emergency resources, such as ambulances, fire trucks, and rescue vehicles, based on the severity and location of incidents. In this way, the system optimizes the distribution of resources, it would ensure the most efficient response and reduce response times.

### Integrate Emergency Services 82:

In the arrangement shown, as one example, the navigation system 10 provides integration between the navigation system 82 and external emergency services, such as local police and medical services. In this way, system 10 enables faster response times and improves overall coordination during emergencies.

### Training and Simulations 83:

In the arrangement shown, as one example, the navigation system 10 provides training modules and simulation scenarios 83 within the navigation system to prepare airport personnel and emergency responders for various emergency situations. In this way, the system improves preparedness and response capabilities.

### Post-Emergency Recovery 84:

In the arrangement shown, as one example, the navigation system 10 provides recovery and restoration in the phase following an emergency. Said another way, system 10 provides directions for debris removal, infrastructure repair, and resuming normal airport operations, and the like.

### Adaptive Learning and Adjustments to the Predetermined Set of Rules 86:

In the arrangement shown, as one example, the navigation system 10 provides leveraging machine learning and AI capabilities 86 through ongoing adjustments to the predetermined set of rules. Said another way, the navigation system continuously learns and adapts to changing conditions and traffic patterns. In this way, the system, in an ongoing manner, analyzes historical data, identifies trends, and provides predictions to optimize future operations and improved decision-making.

### Augmented Reality (AR) Integration 88:

In the arrangement shown, as one example, the navigation system 10 provides integration with AR technologies to provide visual overlays or heads-up displays for vehicle operators. In this way, system 10 enhances situational awareness, displays real-time navigation instructions, and provides alerts or warnings in the operator's field of view.

### Maintenance and Diagnostics Support 90:

In the arrangement shown, as one example, the navigation system 10 provides a maintenance and diagnostics support feature for tracking maintenance activities, tracking vehicle health metrics, predicting maintenance needs, and providing alerts for servicing. In this way, system 10 also guides maintenance vehicles to specific locations within the airport for efficient repairs and inspections of the airport facilities.

Integration with Autonomous Ground Support Equipment (GSE) 91:

In the arrangement shown, as one example, the navigation system 10 provides integration with autonomous ground support equipment, such as baggage carts, cargo loaders, or fueling trucks. In this way, the integration provides synchronized operations and minimizes human intervention, leading to faster turnaround times for aircraft.

### Real-Time Traffic Monitoring 92:

In the arrangement shown, as one example, the navigation system 10 provides continuous and ongoing monitoring of vehicle traffic and congestion levels throughout the airport and/or facility. By analyzing this data in real-time, system 10 dynamically adjusts route plans to avoid congested areas and reroute vehicles for more efficient travel.

### Proximity-Based Routing 93:

In the arrangement shown, as one example, the navigation system 10 provides a navigation system for utilizing proximity-based routing rules to prioritize vehicles that are closest to their destinations. In this way, system 10 reduces overall travel time and optimizes the utilization of resources, such as fuel or battery charge, by minimizing unnecessary detours.

Integration with Air Traffic Control 94:

In the arrangement shown, as one example, the navigation system 10 provides integration with air traffic control systems to receive updates on runway availability and clearance status. In this way, system 10 aligns the route plans of ground vehicles with the movement of aircraft, it would ensure safe and coordinated interactions between different modes of transportation.

### Priority-Based Vehicle Categorization 96:

In the arrangement shown, as one example, the navigation system 10 provides categorization of vehicles based on priority levels and assigns routes accordingly. For example, emergency vehicles and time-sensitive operations like refueling trucks or catering services could be given higher priority, ensuring their efficient movement throughout the airport.

### Dynamic Obstacle Avoidance 98:

In the arrangement shown, as one example, the navigation system 10 provides navigation systems which incorporate obstacle detection and avoidance mechanisms. In this way, system 10 integrates with sensors and real-time data, such as cameras or lidar, it could detect obstacles like other vehicles, pedestrians, or stationary objects, and dynamically reroute vehicles to avoid potential collisions.

### Optimization for Vehicle Characteristics 100:

In the arrangement shown, as one example, the navigation system 10 provides consideration of the specific characteristics of different types of vehicles when generating route plans. For instance, system 10 optimizes routes for larger maintenance vehicles or aircraft tugs, considering factors like turning radius, speed limitations, and vehicle dimensions to ensure safe and efficient navigation.

Integration with Weather Data 101:

In the arrangement shown, as one example, the navigation system 10 provides integration with weather data sources, such as meteorological services, the system could incorporate weather conditions into its route planning. In this way, system 10 can reroute vehicles during adverse weather conditions to avoid areas prone to high winds, low visibility, or other hazardous conditions.

### Alternative Route Recommendations 102:

In the arrangement shown, as one example, the navigation system 10 provides flexibility and re-routing situations where congestion or an incident occurs, the system could provide alternative route recommendations to drivers/operators. In this way, and by incorporation of analyzing real-time data and considering road conditions, it would offer optimized alternative routes to bypass the congested areas, ensuring efficient vehicle movement.

### Priority Adjustment 103:

In the arrangement shown, as one example, the navigation system 10 provides dynamically adjusting the priority levels 103 of vehicles based on changing circumstances. For example, if a vehicle carrying time-sensitive cargo encounters a delay, the system could elevate its priority to expedite its movement or provide an alternative route to ensure prompt delivery.

### Continuous Learning and Improvement 104:

In the arrangement shown, as one example, the navigation system 10 provides continuous learning 104 in real-time from its own performance and user feedback to improve route planning over time. By analyzing historical data, user preferences, and system metrics, it would refine its algorithms, increasing the accuracy and efficiency of adaptive route planning.

### Pre-Route Briefing 106:

In the arrangement shown, as one example, the navigation system 10 provides pre-route briefings 106 to operators before they begin their assigned routes. In this way, system 10 and the briefings include important information such as the planned route, expected traffic conditions, known obstacles, and any relevant updates or instructions. This would ensure that operators are well-informed and prepared for their journeys.

### Dynamic Briefing Updates 108:

In the arrangement shown, as one example, the navigation system 10 provides flexibility in case of any changes or updates during the course of a route, the system could provide dynamic briefing updates 108 to operators. In this way, system 10 includes information about route deviations, traffic congestion, or any emergency incidents that may affect their journey. Operators would receive real-time updates to adjust their plans accordingly.

### Post-Route Debriefing 110:

In the arrangement shown, as one example, the navigation system 10 provides ongoing monitoring after completing a route, the system could facilitate a post-route debriefing session 110. In this way, the system 10 includes features for reviewing the performance and challenges encountered during the journey. In other words, operators are provided the opportunity to provide feedback, report any issues or anomalies, and discuss ways to improve future routes.

### Vertical Takeoff and Landing (VTOL) Vehicles 111:

In the arrangement shown, as one example, the navigation system 10 provides an urban air mobility feature 111 which provides for updating and ongoing changes for airports may integrate VTOL vehicles for short-distance passenger transportation.

Said another way, these vehicles, capable of vertical takeoff and landing, would provide quick and efficient transfers between airports and nearby locations. Airports then are provided with features, via system 10, for ongoing development of designated landing pads and air traffic management systems to accommodate this new form of air transport.

### Landing Pad Management 112:

In the arrangement shown, as one example, the navigation system 10 provides development of designated landing pads 112 and infrastructure to accommodate VTOL operations. System 10 provides features for managing landing pad availability, reservations, and scheduling to ensure a smooth and organized flow of VTOL vehicles. In this way, system 10 also provides real-time information to VTOL operators, indicating landing pad availability and any necessary updates or changes to the assigned landing locations.

Emergency Response and Medical Transport 113: In the arrangement shown, as one example, the navigation system 10 provides VTOL vehicles that can be utilized for emergency response and medical transport 113 within airport environments. In this way, the navigation system enables rapid deployment and coordination of VTOL vehicles in emergency situations, ensuring quick and efficient transportation of medical personnel, equipment, and patients. Furthermore, system 10 facilitates real-time communication between VTOL vehicles, ground emergency services, and airport authorities for effective emergency response management.

Push back Vehicle System 200:

### Integration of Pushback Vehicles 201:

In the arrangement shown, as one example, the navigation system 10 includes pushback vehicles system 200. Pushback vehicle systems 200 are configured to maneuver aircraft away from gates or parking positions, utilizing pushback vehicles 201, which are integrated into the overall ground handling operations at airports Pushback vehicles may be manually controlled and/or autonomous vehicles.

Pushback vehicle system 200 is configured to provide monitoring of a plurality of terminals and provide guidance and locations for pushback actions, including locations for aircraft and the like to pause and/or wait while terminals clear and the like. Furthermore, pushback vehicle system 200 provides for an air traffic controller view which makes clear where vehicles are located and provides communication interactions for all involved in push backs and the like. Similarly, waypoints can be created and provided to parties involved, waypoints can be executed and waypoints and/or routes can be monitored.

### Real-Time Interactive Map 202:

In the arrangement shown, as one example, the pushback vehicle system provides a real-time, interactive map for each pushback vehicle, displaying its current position, intended route, and relevant airport infrastructure.

### Route Requests via System 204:

In the arrangement shown, as one example, the pushback vehicle system provides route planning. Said another way, pushback vehicle operators have the option to submit route requests through the navigation system, indicating the desired destination or specific waypoints.

### Route Approval and Validation 206:

In the arrangement shown, as one example, pushback vehicle systems automatically and/or autonomously validate by a predetermined set of rules the route requests as measured and analyzed against factors such as airspace restrictions, active runways, and ongoing ground operations. In this way, then, approved routes are transmitted back to the pushback vehicles.

### ATC-Pilot Communication 208:

In the arrangement shown, as one example, the pushback vehicle system facilitates direct communication between ATC and pilots. In this way, ATC can provide instructions, clearances, and relevant information to pilots through the system. Furthermore, the pilots can utilize the pushback system to request clearances, report status updates, and seek clarifications from ATC using the same platform.

### ATC-Pushback Operator Communication 210:

In the arrangement shown, as one example, pushback vehicle systems provide direct communication between ATC and pushback operators or self-driving pushback vehicles. In this way, the ATC can relay pushback instructions, verify pushback clearances, and coordinate pushback operations through the system. Furthermore, utilizing the system, pushback operators can seek clarification, report any issues, and receive real-time updates from ATC using the same platform.

### Pilot-Pushback Operator Communication 212:

In the arrangement shown, as one example, the pushback vehicle system facilitates communication between pilots and pushback operators or self-driving pushback vehicles. In this way, pilots can convey specific requirements, provide instructions, or seek assistance from the pushback operator or self-driving pushback vehicles through the system. This ensures seamless communication during pushback operations.

### Communication Via the Navigation System 214:

In the arrangement shown, as one example, pushback vehicle systems provide a radio communication option, as integrated into the system, but also provide a communication option between pushback vehicles and the pilot. In this way, the communication is a secure and dedicated communication channel within the system's interface, eliminating the need for separate radio communication.

### Prioritization of Pushback Locations 216:

In the arrangement shown, as one example, the pushback vehicle system incorporates a prioritization algorithm for pushback locations or engine start positions. In this way, the pushback system considers and analyzes factors such as aircraft departure times, gate availability, and operational requirements to optimize the allocation of pushback locations. Furthermore, in this way, the pushback system ensures that conflicts and congestion are minimized, preventing situations where multiple pushback vehicles are pushing for the same location simultaneously.

### Conflict Avoidance 218:

In the arrangement shown, as one example, the pushback vehicle system actively detects and prevents conflicts between pushback vehicles, taking into account their intended routes, positions, and pushback location assignments. If a potential conflict is detected, the system automatically generates alternative routes or timing adjustments to avoid collisions or delays.

### Engine Start and Navigation Conflict Prevention 220:

In the arrangement shown, as one example, the pushback vehicle system analyzes and evaluates engine start procedures and runway navigation requirements while planning pushback routes. It ensures that pushback operations do not interfere with aircraft engine start procedures or cause conflicts with other taxiing aircraft. By considering these factors, the system minimizes delays and optimizes the flow of traffic on the ground.

### Real-Time Updates and Notifications 222:

In the arrangement shown, as one example, the pushback vehicle system provides real-time updates and notifications to pushback vehicle operators and pilots regarding pushback assignments, route changes, and any other relevant information. In this way, the pushback system ensures that all parties are informed promptly and can adjust their operations accordingly.

### Alternative Embodiments

### Logistics and Supply Chain 300:

It is hereby contemplated for use that system 10 is integrated to support the navigation and coordination of autonomous delivery vehicles, drones, and robots in the logistics industry, enabling streamlined operations and faster delivery times.

### Industrial Complexes 302:

It is hereby contemplated for use that system 10 is integrated to deploy the navigation system within industrial complexes, such as manufacturing plants or warehouses, to guide autonomous vehicles, robotic systems, and personnel, ensuring smooth movement and efficient utilization of resources.

### Smart Hospitals 304:

It is hereby contemplated for use that system 10 is integrated into the navigation system into hospitals to facilitate the movement of medical equipment, supplies, and autonomous robots within the facility, improving workflow efficiency and minimizing delays.

### Theme Parks and Resorts 306:

It is hereby contemplated for use that system 10 is integrated to utilize the navigation system within theme parks and resorts to guide visitors, autonomous shuttles, and maintenance vehicles, optimizing the overall visitor experience and enhancing operational efficiency.

### Campuses and Universities 308:

It is hereby contemplated for use that system 10 is integrated to implement the navigation system in large campuses to assist students, staff, and autonomous vehicles in finding optimal routes between buildings, parking areas, and various facilities.

### Seaports and Harbors 310:

It is hereby contemplated for use that system 10 is integrated to adapt the navigation system for use in seaports and harbors to guide shipping vessels, autonomous boats, and cargo handling equipment, improving navigation efficiency and reducing the risk of collisions.

### Military Bases 312:

It is hereby contemplated for use that system 10 is integrated into the navigation system in military bases to assist with the movement of vehicles, drones, and personnel, enhancing logistical operations and security measures.

### Large Events and Conferences 314:

It is hereby contemplated for use that system 10 is integrated into and utilized in venues hosting major events and conferences to help attendees navigate the premises, optimize traffic flow, and manage emergency response if needed.

### Computing Platform:

In the arrangement shown, as one example, system 10 includes a computing platform 400 (or “computer”, or “computer platform”). Computing platform 400 is formed of any suitable size, shape, and design and is configured to provide computing support, power, and computing processing for both onboard computing functionality as well as communication for off-board or server computing functionality. In this way, an onboard computing system, among other components and features on top of the platform.

In the arrangement shown, as one example, system 10 includes a computer 400. Computer 400 is formed of any suitable size, shape, and design and is configured to provide for the main off-board computing processing and implementation of computer handling of data from data gathering performed.

### Onboard Computing System:

In one arrangement, as is shown, system 10 includes an onboard computing system 800 (or “onboard computing device”). Onboard computing system 500 may be found in various remote locations such as airplanes, safety vehicles, services vehicles, transportation vehicles, emergency vehicles, and the like. Onboarding computing system is formed of any suitable size, shape, and design and configured to handle onboard computing operations, as are necessary for the operation of system 10.

Onboarding computing device is connected with electronic network and/or database and/or server or cloud via communication means, bluetooth communication, bluetooth low energy chip (BLE onboard), and may include a processor, a memory, a microcontroller, a printed circuit board, a microprocessor, a receiver/transceiver, may include at least one antenna, and a global positioning system, among other components.

Computing devices may be formed of and/or include any computing device capable of displaying and manipulating data in the manners described herein. Computing devices may include for example a desktop computer, a laptop computer, a tablet, smart phone, or any other computing device or other interactive device.

Computing device may be a single consolidated component, or alternatively, computing device may be formed of a plurality of interconnected components that may be co-located or located at different geographic locations. Computing devices may be cloud based or it may be hardware based, or cloud capable.

In addition, the connected components of a computing device, including processor, memory, software and interactive user display, may be co-located with a computing device or located at different geographic locations, independent control features, and the like. That is, a computing device may be made of any form of a device or system that individually or collectively performs the computing operations of system 10.

Printed Circuit Board: In the arrangement shown, as one example, system 10 may include a printed circuit board (“PCB”). PCB is formed of any suitable size, shape and design and is configured to facilitate carrying and/or holding other components and/or parts necessary to carry out various computation and/or related functions of system 10.

PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

In an alternative embodiment, system 10 may not include an onboard computer device, but instead houses only a receiver and/or transceiver for sending and/or receiving information which is both sensed and/or information which is sensed and/or captured by the image capturing devices of system 10. In this way, system 10 may be connected to a mobile computing device via a cellular connection, a direct connection, or other connections which provide a means of receiving and/or sending communications.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”).

Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as one example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

### Remote Computing System:

In one arrangement, as is shown, system 10 includes a remote computing system 600 (or “remote computing device”). Remote computing device 600 is formed of any suitable size, shape, and design and configured to handle onboard computing operations, as are necessary for the operation of system 10. Remote computing device is connected with electronic network and/or database and/or server or cloud via communication means and includes a processor, a memory, a microcontroller, a printed circuit board, a microprocessor, a receiver/transceiver, may include at least one antenna, a power supply, and a communications system, among other components.

Computing devices may be formed of any computing device capable of displaying and manipulating data in the manners described herein. Computing devices may include for example a desktop computer, a laptop computer, a tablet, smart phone, or any other computing device or other interactive device.

Computing devices may be a single consolidated component, or alternatively, computing devices may be formed of a plurality of interconnected components that may be co-located or located at different geographic locations. Computing devices may be cloud based or it may be hardware based, or cloud capable. In addition, the connected components of computing devices, including processor, memory, software and interactive user display, may be co-located with computing devices or located at different geographic locations. That is, computing devices may be made of any form of a device or system that individually or collectively performs the computing operations of system 10.

### Sensor System:

In the arrangement shown, as one example, system 10 includes a sensor system 700. Sensor system 700 is formed of any suitable size, shape, and design and may include one or more sensors and/or one or more sensing technologies. In the arrangement shown, as one example, the sensor system is configured to detect and communicate information related to system 10 as well as the surroundings and/or environment of system 10.

In the arrangement shown, as one example, various sensors are utilized within system 10 to detect system status such as distance, temperature changes, and other operating status parameters within system 10.

In the arrangement shown, as one example, a sensory system and perhaps a LIDAR sensor system is utilized to understand the environment surrounding system 10 is engaging with. This might include both distance and imaging sensors and/or camera sensors.

### Other Sensors:

In addition to the distance and image sensors discussed herein, system 10 may also include other sensors, such as temperature sensors, moisture sensors, heat sensors, light sensors, motion sensors, and other sensors. In the arrangement shown, as one example, system 10 includes at least one other sensor. Other sensors are formed of any suitable size, shape and design and are configured to facilitate sensing of surfaces and/or environmental information and converting the characteristics of the outside space and/or environment into computer readable information. Other sensors are used to detect and respond to some type of input from the physical environment.

Other sensors may be used for sensing a single component of an environment. For example, the specific input of other sensors may be light, heat, motion, moisture, pressure, or any one of a great number of other information related to system 10. Another sensor is a device, module, or subsystem whose purpose is to detect events or changes in system 10 and send the information to other electronics, frequently a computer processor. The output of another sensor is generally a signal that is generally converted to human-readable display at the sensor location or transmitted electronically over a network for reading or further processing. Both analog sensors and/or digital sensors are hereby contemplated for use. In one arrangement, another sensor and/or microsensor sends information to a processor for use with other electronics.

### Application Server:

In the arrangement shown, as one example, system 10 may comprise remote servers, databases, and/or computers that fulfill the functions disclosed and described herein. In the embodiment depicted, system 10 comprises an application server 800. Application server 800 comprises one or more computer systems adapted to transmit and receive data regarding selected datasets related to various users and/or datasets related to multiple users. Application server 800 is adapted to query databases, and may utilize unique identification codes, to retrieve information and associated information related to system 10.

Application server 800 may transmit data and/or related documents with respect to a system 10. Application server 800 is also adapted to query a database. Additionally, application server 800 may communicate with a cloud computing system or a mobile application, which can also be adapted to present the data in a form conducive to being viewed on a mobile device and/or handheld device.

As one of ordinary skills in the art may understand, application server 800, database, and other databases mentioned herein may be implemented in one or more servers. Furthermore, each may be on multiple servers to increase system efficiency, especially when handling large data gathering, following extended guidelines, extended ranges, ranges discussed herein. Additionally, multiple servers may have mirrored data to prevent data loss in case of disk failure and/or to decrease access and response times for database queries. In alternative embodiments, application server 600, and other database procedures may be carried out on computer-readable instructions and data stored on the customer's mobile computing device.

In addition to the above identified features, options, controls, and components, system 10 may also include other features and functionalities, among other options, controls, and components.

It will be appreciated by those skilled in the art that other various modifications could be made to the system, process, and method of use without parting from the spirit and scope of this disclosure. All such modifications and changes fall within the scope of the claims and are intended to be covered thereby.

1. A logistics system, comprising:
a navigation system;
the navigation system having a plurality of routes;
the navigation system having a route request feature;
the navigation system having a route approval feature.

2. The system of claim 1, further comprising:
wherein the large facility is an airport;
wherein the navigation system includes taxiing control and monitoring of aircraft after landing and prior to departure of a terminal;
the navigation system having an incursion prevention feature;
wherein the incursion prevention feature integrates with aircraft which are landing and those vehicles which are on the ground to prevent possibilities of collision.

3. The system of claim 1, further comprising:
the navigation system having a reroute feature;
wherein when the operator deviates from the selected waypoint, the navigation system provides a reroute based on real-time circumstances of the plurality of waypoints;
wherein the re-route is an alternative route option;
wherein the operator receives a notification that the operator has deviated from the selected route;
wherein an air traffic controller receives an alert that a vehicle of the plurality of vehicles has deviated from the selected route.

4. The system of claim 1, further comprising:
a personal portable station.

5. The system of claim 1, further comprising:
a vehicle to vehicle communication feature.

6. The system of claim 1, further comprising:
a pushback vehicle system;
the pushback vehicle systems feature having a real time interactive map feature;
the pushback vehicle systems feature having a route requests via system feature;
the pushback vehicle systems feature having a route approval and validation feature;
the pushback vehicle systems feature having an ATC pilot communication;
the pushback vehicle systems feature having an ATC pushback operator communication;
the pushback vehicle systems feature having a pilot pushback operator communication;
the pushback vehicle systems feature having a communication via a navigation system;
the pushback vehicle systems feature having a prioritization of pushback locations feature;
the pushback vehicle systems feature having a conflict avoidance feature;
the pushback vehicle systems feature having an engine start and navigation conflict prevention feature;
the pushback vehicle systems feature having a real time update and notification feature;
an integration of pushback vehicle systems feature.

7. The system of claim 1, further comprising:
a pre-route briefing feature;
a dynamic briefing update feature;
a post route debriefing feature.

8. The system of claim 1, further comprising:
a vertical takeoff and landing vehicles feature;
a landing pad management feature;
an emergency response and medical transport feature.

9. The system of claim 1, further comprising:
a plurality of autonomous ground support vehicles;
an integration with the plurality of autonomous ground support vehicles feature;
a real time traffic monitoring feature;
a proximity based routing feature;
an integration with air traffic control system;
a priority based vehicle categorization feature;
a dynamic obstacle avoidance system;
an optimization for vehicle characteristics features;
an integration of weather data feature;
an alternative route recommendations feature;
a priority adjustment feature;
a continuous learning and improvement feature.

10. The system of claim 1, further comprising:
an integration with air traffic control system;
a priority based vehicle categorization feature;
a dynamic obstacle avoidance system;
an optimization for vehicle characteristics features;
an integration of weather data feature;
an alternative route recommendations feature;
a priority adjustment feature;
a continuous learning and improvement feature.

11. The system of claim 1, further comprising:
a computing system;
an onboard computing system;
a remote computing system;
a sensor system;
an application programming interface.

12. The system of claim 1, further comprising:
a predetermined set of rules;
an adaptive learning feature;
an augmented reality integration feature;
a maintenance and diagnostics support feature.

13. The system of claim 1, further comprising:
a predetermined set of rules;
wherein the predetermined set of rules are adapted to an airport facility;
an adaptive learning feature;
an augmented reality integration feature;
a maintenance and diagnostics support feature.

14. The system of claim 1, further comprising:
a plurality of emergency vehicles;
a real time emergency resource allocation feature;
an integration of emergency services feature;
a training and simulations systems;
a post emergency recovery feature.

15. The system of claim 1, further comprising;
an emergency response system;
a system for integrating with existing systems;
an adaptability feature;
a data analytics feature;
an integration with mobile devices;
a plurality of designated zones;
a plurality of communication protocols;
a sensor integration feature;
a collision avoidance system;
a dynamic routing system;
a vehicle identification and authentication system;
a situational awareness feature;
a remote monitoring and control system;
a training and testing system;
an energy efficiency optimization feature;
an emergency routing feature;
an emergency notification system;
the emergency notification system having a plurality of emergency notifications;
a real time incident monitoring system;
a digital communication system;
wherein the digital communication system communicates critical information;
an evacuation assistance feature;
a resource allocation feature.

16. The system of claim 1, further comprising:
a self driving functionality;
an automated route updates feature;
a collision avoidance system;
a runway incursion prevention feature;
a data logging and analysis feature;
a real time updates feature.

17. The system of claim 1, further comprising:
a vehicle tracking system;
an advanced analytics and optimization system;
a scalability and flexibility feature;
a plurality of safety precautions;
integrated control station.

18. The system of claim 1, further comprising:
A large facility emergency system, the emergency management system comprising:
a plurality of emergency vehicles;
a real time emergency resource allocation feature;
an integration of emergency services feature;
a training and simulations systems;
a post emergency recovery feature;
an emergency response system;
a system for integrating with existing systems;
an adaptability feature;
a data analytics feature;
an integration with mobile devices;
a plurality of designated zones;
a plurality of communication protocols;
a sensor integration feature;
a collision avoidance system;
a dynamic routing system;
a vehicle identification and authentication system;
a situational awareness feature;
a remote monitoring and control system;
a training and testing system;
an energy efficiency optimization feature;
an emergency routing feature;
an emergency notification system;
the emergency notification system having a plurality of emergency notifications;
a real time incident monitoring system;
a digital communication system;
wherein the digital communication system communicates critical information;
an evacuation assistance feature;
a resource allocation feature.

19. A large facility logistics system, comprising:
a plurality of vehicles;
a navigation system;
the an active map for each of the plurality of vehicles;
the navigation system having a plurality of routes;
the navigation system having a route request feature;
the navigation system having a route approval feature;
the navigation system having a route validation feature;
the navigation system having a route monitoring feature;
wherein the route monitoring feature has an alert and notification feature;
an autonomous route planning feature;
wherein the autonomous route planning feature analyzes a current traffic flow;
wherein the autonomous route planning feature determines available routes;
wherein the autonomous route planning feature provides a plurality of available waypoint options;
wherein the operator selects one of the plurality of available waypoint options;
wherein the navigation system provides navigation for the selection the operator makes from one of the plurality of available waypoint options.

20. A method of mapping and navigating airports, comprising the steps:
each of the airports having a plurality of vehicles; each of the airports having a plurality of incoming and outgoing aircraft;
providing a navigation system; the navigation system having an active map for each of the plurality of vehicles;
mapping a plurality of routes; wherein mapping a plurality of routes considers real time traffic flow across a set of known routes;
requesting a route; wherein the operator selects a requested route;
approving a requested route;
validating a requested route;
monitoring each of the plurality of vehicles during progress of route;
alerting an operator of the vehicle if a vehicle of the plurality of vehicles deviates from the requested route;
alerting a controller of the air traffic controller if a vehicle of the plurality of vehicles deviates from the requested route; wherein the controller is a human controller or a computer controller.
